(19) United States
(12) Patent Application Publication
(10) Pub. No.: US 2025/0047789 A1
(43) Pub. Date: Feb. 6, 2025

(54) TECHNIQUES FOR BENCHMARKING PAIRING STRATEGIES IN A CONTACT CENTER SYSTEM

(71) Applicant: Afiniti, Ltd., Hamilton (BM)

(72) Inventors: Umut Demirtas, Atasehir (TR); Mustafa KIRAC, Atasehir (TR); Kevin Alland, Rockville, MD (US); Blake Jay Riley, Indianapolis, IN (US)

(73) Assignee: Afiniti, Ltd., Hamilton (BM)

(21) Appl. No.: 18/926,536

(22) Filed: Oct. 25, 2024

Related U.S. Application Data
(63) Continuation of application No. PCT/US2023/019999, filed on Apr. 26, 2023.
(60) Provisional application No. 63/335,604, filed on Apr. 27, 2022.
(60) Provisional application No. 63/459,537, filed on Apr. 14, 2023.

(51) Int. Cl. H04M 3/523

(52) U.S. Cl. CPC H04M 3/5233

(57) ABSTRACT

There is provided a method. The method comprises selecting a pairing strategy (PS) set from a group of PS sets, the group of PS sets comprising: i) a first PS set comprising a first PS (first pairing algorithm/module) and ii) a second PS set comprising a second PS and a third PS, and as a result of selecting a PS set from the group of PS sets, using one or more PSs included in the selected PS set to establish one or more contact-agent pairs.

### CROSS REFERENCE TO RELATED APPLICATIONS

This application is a continuation of International Patent Application No. PCT/US2023/019999, filed on 2023 Apr. 26, which claims the benefit of U.S. Provisional Application No. 63/335,604, filed 2022 Apr. 27 and U.S. Provisional Application No. 63/459,537, filed 2023 Apr. 14. The above identified applications are incorporated by this reference.

### TECHNICAL FIELD

This disclosure generally relates to contact centers. One aspect of the disclosure relates to techniques for benchmarking pairing strategies in a contact center system. Another aspect of the disclosure relates to changing the time periods of applying different pairing strategies when they are applied sequentially.

### BACKGROUND

A typical contact center algorithmically assigns contacts arriving at the contact center to agents available to handle those contacts. At times, the contact center may have agents available and waiting for assignment to inbound or outbound contacts (e.g., telephone calls, Internet chat sessions, email) or outbound contacts. At other times, the contact center may have contacts waiting in one or more queues for an agent to become available for assignment.

In some typical contact centers, contacts are assigned to agents ordered based on time of arrival, and agents receive contacts ordered based on the time when those agents became available. This strategy may be referred to as a “first-in, first-out”, “FIFO”, or “round-robin” strategy.

Some contact centers may use a “performance based routing” or “PBR” approach to ordering the queue of available agents or, occasionally, contacts. PBR ordering strategies attempt to maximize the expected outcome of each contact-agent interaction but do so typically without regard for utilizing agents in a contact center uniformly.

### SUMMARY

Certain challenges presently exist. For example, when a contact center changes from using one type of pairing strategy (e.g., FIFO) to another type of pairing strategy (e.g., PBR), overall contact center performance may continuously vary over time, and it can be difficult to measure the amount of performance change attributable to using a new pairing strategy because there may be other factors that account for some of the increased or decreased performance over time.

Therefore, there is a need for a method and/or a system that enables benchmarking of alternative routing strategies to measure changes in performance attributable to the alternative routing strategies.

Accordingly, in one aspect of the embodiments of this disclosure, there is provided a method. The method comprises selecting a pairing strategy (PS) set from a group of PS sets, the group of PS sets comprising: i) a first PS set comprising a first PS (first pairing algorithm/module) and ii) a second PS set comprising a second PS and a third PS; and as a result of selecting a PS set from the group of PS sets, using one or more PSs included in the selected PS set to establish one or more contact-agent pairs.

In another aspect, there is provided a method that comprises obtaining first contact center information, the first contact center information: i) identifying a first set of available agents that are available to be paired with a contact and ii) identifying a first set of contacts that are waiting to be paired with an available agent. The method further comprises selecting a pairing strategy (PS) set from a group of two or more PS sets, the group of PS sets comprising: i) a first PS set comprising a first PS and ii) a second PS set comprising a second PS and a third PS. The method further comprises, after obtaining the first contact center information and after selecting the pairing strategy set, performing a first pairing process using the first contact center information, wherein the first pairing process implements a PS included in the selected PS set.

In another aspect, there is provided a method comprising obtaining first pairing strategy (PS) group information that includes at least a first PS identifier identifying a first PS and a second PS identifier identifying a second PS. The method further comprises obtaining second PS group information that includes at least a third PS identifier identifying a third PS; determining a first proportion value that indicates a first proportion of a time period, wherein the first proportion is associated with (i) the first PS identifier and the second PS identifier or (ii) the third PS identifier; determining a first sub-proportion value that indicates a first sub-proportion of a time period, wherein the first sub-proportion is associated with the first PS identifier or the second PS identifier, and applying the first PS during a first part of a first time period, wherein the first part of the first time period is selected based on the first proportion value and the first sub-proportion value. The method further comprises applying the second PS during a second part of the first time period, wherein the second part of the first time period is selected based on the first proportion value and the first sub-proportion; applying the third PS during a third part of the first time period, wherein the third part of the first time period is selected based on the first proportion value; and obtaining performance measurement data that indicates performance of the first PS and the second PS during the first time period. The method further comprises, based on the performance measurement data, determining an updated first sub-proportion value that indicates an updated first sub-proportion of a time period, wherein the updated first sub-proportion is associated with the first PS identifier or the second PS identifier. The method further comprises applying the first PS during a first part of a second time period, wherein the first part of the second time period is selected based on the updated first sub-proportion value; applying the second PS during a second part of the second time period, wherein the second part of the second time period is selected based on the updated first sub-proportion value; and applying the third PS during a third part of the second time period.

In another aspect, there is provided a computer program comprising instructions which when executed by processing circuitry cause the processing circuitry to perform the method of any one of the embodiments described above.

In another aspect, there is provided a carrier containing the computer program of the above embodiment, wherein the carrier is one of an electronic signal, an optical signal, a radio signal, and a computer readable storage medium.

In another aspect, there is provided an apparatus. The apparatus is configured to select a pairing strategy (PS) set from a group of PS sets, the group of PS sets comprising: i) a first PS set comprising a first PS (first pairing algorithm/module) and ii) a second PS set comprising a second PS and a third PS. The apparatus is further configured to, as a result of selecting a PS set from the group of PS sets, use one or more PSs included in the selected PS set to establish one or more contact-agent pairs.

In another aspect, there is provided an apparatus. The apparatus is configured to obtain first contact center information, the first contact center information: i) identifying a first set of available agents that are available to be paired with a contact and ii) identifying a first set of contacts that are waiting to be paired with an available agent. The apparatus is configured to select a pairing strategy (PS) set from a group of two or more PS sets, the group of PS sets comprising: i) a first PS set comprising a first PS and ii) a second PS set comprising a second PS and a third PS; and, after obtaining the first contact center information and after selecting the pairing strategy set, perform a first pairing process using the first contact center information, wherein the first pairing process implements a PS included in the selected PS set.

In another aspect, there is provided an apparatus. The apparatus is configured to obtain first pairing strategy (PS) group information that includes at least a first PS identifier identifying a first PS and a second PS identifier identifying a second PS. The apparatus is further configured to obtain second PS group information that includes at least a third PS identifier identifying a third PS, determine a first proportion value that indicates a first proportion of a time period, wherein the first proportion is associated with (i) the first PS identifier and the second PS identifier or (ii) the third PS identifier, and determine a first sub-proportion value that indicates a first sub-proportion of a time period, wherein the first sub-proportion is associated with the first PS identifier or the second PS identifier. The apparatus is further configured to apply the first PS during a first part of a first time period, wherein the first part of the first time period is selected based on the first proportion value and the first sub-proportion value; apply the second PS during a second part of the first time period, wherein the second part of the first time period is selected based on the first proportion value and the first sub-proportion; and apply the third PS during a third part of the first time period, wherein the third part of the first time period is selected based on the first proportion value. The apparatus is further configured to obtain performance measurement data that indicates performance of the first PS and the second PS during the first time period; and based on the performance measurement data, determine an updated first sub-proportion value that indicates an updated first sub-proportion of a time period, wherein the updated first sub-proportion is associated with the first PS identifier or the second PS identifier. The apparatus is further configured to apply the first PS during a first part of a second time period, wherein the first part of the second time period is selected based on the updated first sub-proportion value; apply the second PS during a second part of the second time period, wherein the second part of the second time period is selected based on the updated first sub-proportion value; and apply the third PS during a third part of the second time period.

In another aspect, there is provided an apparatus comprising a memory; and processing circuitry coupled to the memory. The apparatus is configured to perform the method of any one of the embodiments described above.

The present disclosure will now be described in more detail with reference to particular embodiments thereof as shown in the accompanying drawings. While the present disclosure is described below with reference to particular embodiments, it should be understood that the present disclosure is not limited thereto. Those of ordinary skill in the art having access to the teachings herein will recognize additional implementations, modifications, and embodiments, as well as other fields of use, which are within the scope of the present disclosure as described herein, and with respect to which the present disclosure may be of significant utility.

### BRIEF DESCRIPTION OF THE DRAWINGS

In order to facilitate a fuller understanding of the present disclosure, reference is now made to the accompanying drawings, in which like elements are referenced with like numerals. These drawings should not be construed as limiting the present disclosure, but are intended to be illustrative only.

FIG. 1A shows a schematic representation of a benchmarking sequence according to embodiments of the present disclosure.

FIG. 1B shows a schematic representation of benchmarking sequence according to embodiments of the present disclosure.

FIG. 2A shows a schematic representation of benchmarking sequence according to embodiments of the present disclosure.

FIG. 2B shows a schematic representation of benchmarking sequence according to embodiments of the present disclosure.

FIG. 3A shows a schematic representation of benchmarking sequence according to embodiments of the present disclosure.

FIG. 3B shows a schematic representation of benchmarking sequence according to embodiments of the present disclosure.

FIG. 3C shows a schematic representation of benchmarking sequence according to embodiments of the present disclosure.

FIG. 3D shows a schematic representation of benchmarking sequence according to embodiments of the present disclosure.

FIG. 4 shows a flow diagram of a benchmarking method according to embodiments of the present disclosure.

FIG. 5 shows a flow diagram of a benchmarking method according to embodiments of the present disclosure.

FIG. 6 shows a block diagram of a contact center system according to embodiments of the present disclosure.

FIG. 7A shows a schematic representation of benchmarking sequence according to embodiments of the present disclosure.

FIG. 7B shows a schematic representation of benchmarking sequence according to embodiments of the present disclosure.

FIG. 8 shows a flow diagram of a benchmarking method according to embodiments of the present disclosure.

FIG. 9A shows an example of epoch benchmarking according to some embodiments.

FIG. 9B shows an example of inline benchmarking according to some embodiments.

FIG. 10A shows an example of hybrid benchmarking according to some embodiments.

FIG. 10B shows an example of hybrid benchmarking according to some embodiments.

FIG. 11 shows a process according to some embodiments.

FIG. 12 shows an apparatus according to some embodiments.

FIG. 13 shows a process according to some embodiments.

FIG. 14A shows an example of hybrid benchmarking according to some embodiments.

FIG. 14B shows an example of hybrid benchmarking according to some embodiments.

FIG. 15A shows an example of hybrid benchmarking according to some embodiments.

FIG. 15B shows an example of hybrid benchmarking according to some embodiments.

FIG. 16A shows an example of hybrid benchmarking according to some embodiments.

FIG. 16B shows an example of hybrid benchmarking according to some embodiments.

FIG. 17 shows a system according to some embodiments.

FIG. 18A shows a method of applying different pairing strategies according to some embodiments.

FIG. 18B shows a method of applying different pairing strategies according to some embodiments.

FIG. 19 shows a process according to some embodiments.

### DETAILED DESCRIPTION

A typical contact center algorithmically assigns contacts arriving at the contact center to agents available to handle those contacts. At times, the contact center may have agents available and waiting for assignment to inbound or outbound contacts (e.g., telephone calls, Internet chat sessions, email) or outbound contacts. At other times, the contact center may have contacts waiting in one or more queues for an agent to become available for assignment.

In some typical contact centers, contacts are assigned to agents ordered based on time of arrival, and agents receive contacts ordered based on the time when those agents became available. This strategy may be referred to as a “first-in, first-out”, “FIFO”, or “round-robin” strategy. For example, a longest-available agent pairing strategy preferably selects the available agent who has been available for the longest time.

Some contact centers may use a “performance based routing” or “PBR” approach to ordering the queue of available agents or, occasionally, contacts. PBR ordering strategies attempt to maximize the expected outcome of each contact-agent interaction but do so typically without regard for utilizing agents in a contact center uniformly. Some variants of PBR may include a highest-performing-agent pairing strategy, preferably selecting the available agent with the highest performance, or a highest-performing-agent-for-contact-type pairing strategy, preferably selecting the available agent with the highest performance for the type of contact being paired.

For yet another example, some contact centers may use a “behavioral pairing” or “BP” strategy, under which contacts and agents may be deliberately (preferentially) paired in a fashion that enables the assignment of subsequent contact-agent pairs such that when the benefits of all the assignments under a BP strategy are totaled they may exceed those of FIFO and PBR strategies. BP is designed to encourage balanced utilization of agents within a skill queue while nevertheless simultaneously improving overall contact center performance beyond what FIFO or PBR methods will allow. This is a remarkable achievement inasmuch as BP acts on the same calls and same agents as FIFO or PBR methods, utilizes agents approximately evenly as FIFO provides, and yet improves overall contact center performance. BP is described in, e.g., U.S. patent application Ser. No. 14/871,658, filed Sep. 30, 2015, which is incorporated by reference herein. Additional information about these and other features regarding the pairing or matching modules (sometimes also referred to as “SATMAP”, “routing system”, “routing engine”, etc.) is described in, for example, U.S. Pat. No. 8,879,715, which is incorporated herein by reference.

Some contact centers may use a variety of other possible pairing strategies. For example, in a longest-available agent pairing strategy, an agent may be selected who has been waiting (idle) the longest time since the agent's most recent contact interaction (e.g., call) has ended. In a least-occupied agent pairing strategy, an agent may be selected who has the lowest ratio of contact interaction time to waiting or idle time (e.g., time spent on calls versus time spent off calls). In a fewest-contact-interactions-taken-by-agent pairing strategy, an agent may be selected who has the fewest total contact interactions or calls. In a randomly-selected-agent pairing strategy, an available agent may be selected at random (e.g., using a pseudorandom number generator). In a sequentially-labeled-agent pairing strategy, agents may be labeled sequentially, and the available agent with the next label in sequence may be selected.

In situations where multiple contacts are waiting in a queue, and an agent becomes available for connection to one of the contacts in the queue, a variety of pairing strategies may be used. For example, in a FIFO or longest-waiting-contact pairing strategy, the agent may be preferably paired with the contact that has been waiting in queue the longest (e.g., the contact at the head of the queue). In a randomly-selected-contact pairing strategy, the agent may be paired with a contact selected at random from among all or a subset of the contacts in the queue. In a priority-based routing or highest-priority-contact pairing strategy, the agent may be paired with a higher-priority contact even if a lower-priority contact has been waiting in the queue longer.

Contact centers may measure performance based on a variety of metrics. For example, a contact center may measure performance based on one or more of sales revenue, sales conversion rates, customer retention rates, average handle time, customer satisfaction (based on, e.g., customer surveys), etc. Regardless of what metric or combination of metrics a contact center uses to measure performance, or what pairing strategy (e.g., FIFO, PBR, BP) a contact center uses, performance may vary over time. For example, year-over-year contact center performance may vary as a company shrinks or grows over time or introduces new products or contact center campaigns. Month-to-month contact center performance may vary as a company goes through sales cycles, such as a busy holiday season selling period, or a heavy period of technical support requests following a new product or upgrade rollout. Day-to-day contact center performance may vary if, for example, customers are more likely to call during a weekend than on a weekday, or more likely to call on a Monday than a Friday. Intraday contact center performance may also vary. For example, customers may be more likely to call at when a contact center first opens (e.g., 8:00 AM), or during a lunch break (e.g., 12:00 PM), or in the evening after typical business hours (e.g., 6:00 PM), than at other times during the day. Intra-hour contact center performance may also vary. For example, more urgent, high-value contacts may be more likely to arrive the minute the contact center opens (e.g., 9:00 or 9:01) than even a little later (e.g., 9:05). Contact center performance may also vary depending on the number and caliber of agents working at a given time. For example, the 9:00-5:00 PM shift of agents may perform, on average, better than the 5:00-9:00 AM shift of agents.

These examples of variability at certain times of day or over larger time periods can make it difficult to attribute changes in performance over a given time period to a particular pairing strategy. For example, if a contact center used FIFO routing for one year with an average performance of 20% sales conversion rate, then switched to PBR in the second year with an average performance of 30% sales conversion rate, the apparent change in performance is a 50% improvement. However, this contact center may not have a reliable way to know what the average performance in the second year would have been had it kept the contact center using FIFO routing instead of PBR. In real-world situations, at least some of the 50% gain in performance in the second year may be attributable to other factors or variables that were not controlled or measured. For example, the contact center may have retrained its agents or hired higher-performing agents, or the company may have introduced an improved product with better reception in the marketplace. Consequently, contact centers may struggle to analyze the internal rate of return or return on investment from switching to a different to a different pairing strategy due to challenges associated with measuring performance gain attributable to the new pairing strategy.

In some embodiments, a contact center may switch (or “cycle”) periodically among at least two different pairing strategies (e.g., between FIFO and PBR; between PBR and BP; among FIFO, PBR, and BP). Additionally, the outcome of each contact-agent interaction may be recorded along with an identification of which pairing strategy (e.g., FIFO, PBR, or BP) had been used to assign that particular contact-agent pair. By tracking which interactions produced which results, the contact center may measure the performance attributable to a first strategy (e.g., FIFO) and the performance attributable to a second strategy (e.g., PBR). In this way, the relative performance of one strategy may be benchmarked against the other. The contact center may, over many periods of switching between different pairing strategies, more reliably attribute performance gain to one strategy or the other.

Several benchmarking techniques may achieve precisely measurable performance gain by reducing noise from confounding variables and eliminating bias in favor of one pairing strategy or another. In some embodiments, benchmarking techniques may be time-based (“epoch benchmarking”). In other embodiments, benchmarking techniques may involve randomization or counting (“inline benchmarking”). In other embodiments, benchmarking techniques may be a hybrid of epoch and inline benchmarking.

In epoch benchmarking, as explained in detail below, the switching frequency (or period duration) can affect the accuracy and fairness (e.g., statistical purity) of the benchmark. For example, assume the period is two years, switching each year between two different strategies. In this case, the contact center may use FIFO in the first year at a 20% conversion rate and PBR in the second year at a 30% conversion rate, and measure the gain as 50%. However, this period is too large to eliminate or otherwise control for expected variability in performance. Even shorter periods such as two months, switching between strategies each month, may be susceptible to similar effects. For example, if FIFO is used in November, and PBR is used December, some performance improvement in December may be attributable to increased holiday sales in December rather than the PBR itself.

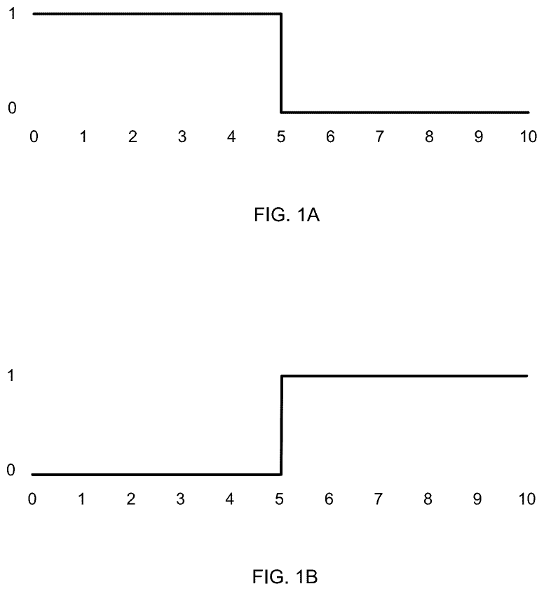

In some embodiments, to reduce or minimize the effects of performance variability over time, the period may be much shorter (e.g., less than a day, less than an hour, less than twenty minutes). FIG. 1A shows a benchmarking period of ten units (e.g., ten minutes). In FIG. 1A, the horizontal axis represents time, and the vertical axis represents whether a first pairing strategy (“1”) or a second pairing strategy (“0”) is used. For the first five minutes (e.g., 9:00-9:05 AM), the first pairing strategy (e.g., BP) may be used. After five minutes, the contact center may switch to the second pairing strategy (e.g., FIFO or PBR) for the remaining five minutes of the ten-minute period (9:05-9:10 AM). At 9:10 AM, the second period may begin, switching back to the first pairing strategy (not shown in FIG. 1A). If the period is 30 minutes (i.e., each unit of time in FIG. 1A is equal to three minutes), the first pairing strategy may be used for the first 15 minutes, and the second pairing strategy may be used for the second 15 minutes.

With short, intra-hour periods (10 minutes, 20 minutes, 30 minutes, etc.), the benchmark is less likely to be biased in favor of one pairing strategy or another based on long-term variability (e.g., year-over-year growth, month-to-month sales cycles). However, other factors of performance variability may persist. For example, if the contact center always applies the period shown in FIG. 1A when it opens in the morning, the contact center will always use the first strategy (BP) for the first five minutes. As explained above, the contacts who arrive at a contact center the moment it opens may be of a different type, urgency, value, or distribution of type/urgency/value than the contacts that arrive at other times of the hour or the day. Consequently, the benchmark may be biased in favor of the pairing strategy used at the beginning of the day (e.g., 9:00 AM) each day.

In some embodiments, to reduce or minimize the effects of performance variability over even short periods of time, the order in which pairing strategies are used within each period may change. For example, as shown in FIG. 1B, the order in which pairing strategies are used has been reversed from the order shown in FIG. 1A. Specifically, the contact center may start with the second pairing strategy (e.g., FIFO or PBR) for the first five minutes, then switch to the first pairing strategy (BP) for the following five minutes.

In some embodiments, to help ensure trust and fairness in the benchmarking system, the benchmarking schedule may be established and published or otherwise shared with contact center management ahead or other users of time. In some embodiments, contact center management or other users may be given direct, real-time control over the benchmarking schedule, such as using a computer program interface to control the cycle duration and the ordering of pairing strategies.

Embodiments of the present disclosure may use any of a variety of techniques for varying the order in which the pairing strategies are used within each period. For example, the contact center may alternate each hour (or each day or each month) between starting with the first ordering shown in FIG. 1A and starting with the second ordering shown in FIG. 1B. In other embodiments, each period may randomly select an ordering (e.g., approximately 50% of the periods in a given day used the ordering shown in FIG. 1A, and approximately 50% of the periods in a given day use the ordering shown in FIG. 1B, with a uniform and random distribution of orderings among the periods).

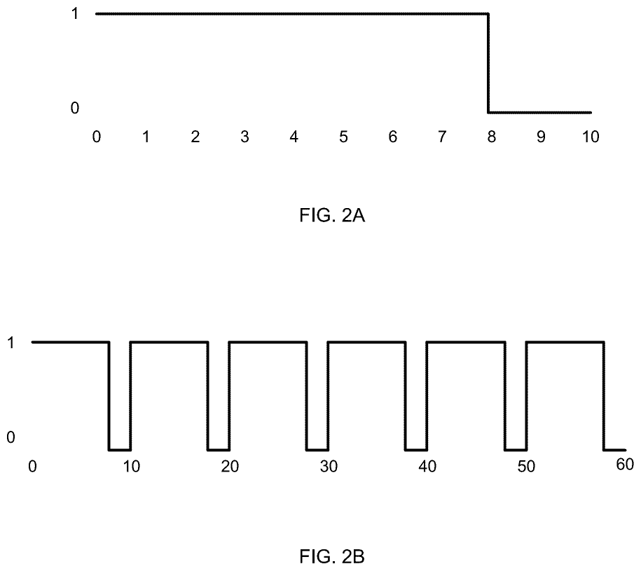

In the examples of FIGS. 1A and 1B, each pairing strategy is used for the same amount of time within each period (e.g., five minutes each). In these examples, the “duty cycle” is 50%. However, notwithstanding other variables affecting performance, some pairing strategies are expected to perform better than others. For example, BP is expected to perform better than FIFO. Consequently, a contact center may wish to use BP for a greater proportion of time than FIFO—so that more pairings are made using the higher-performing pairing strategy. Thus, the contact center may prefer a higher duty cycle (e.g., 60%, 70%, 80%, 90%, etc.) representing more time (or proportion of contacts) paired using the higher-performing pairing strategy. FIG. 2A shows an example of a ten-minute period with an 80% duty cycle. For the first eight minutes (e.g., 9:00-9:08 AM), the first pairing strategy (e.g., BP) may be used. After the first eight minutes, the contact center may switch to the second pairing strategy (e.g., FIFO) for the remaining two minutes of the period (9:08-9:10) before switching back to the first pairing strategy again (not shown). If, for another example, a thirty-minute period is used, the first pairing strategy may be used for the first twenty-four minutes (e.g., 9:00-9:24 AM), and the second pairing strategy may be used for the next six minutes (e.g., 9:24-9:30 AM).

As shown in FIG. 2B, the contact center may proceed through six ten-minute periods over the course of an hour. In this example, each ten-minute period has an 80% duty cycle favoring the first pairing strategy, and the ordering within each period starts with the favored first pairing strategy. Over the hour, the contact center may switch pairing strategies twelve times (e.g., at 9:08, 9:10, 9:18, 9:20, 9:28, 9:30, 9:38, 9:40, 9:48, 9:50, 9:58, and 10:00). Within the hour, the first pairing strategy was used a total of 80% of the time (48 minutes), and the second pairing strategy was used the other 20% of the time (12 minutes). For a thirty-minute period with an 80% duty cycle (not shown), over the hour, the contact center may switch pairing strategies four times (e.g., at 9:24, 9:30, 9:48, and 10:00), and the total remains 48 minutes using the first pairing strategy and 12 minute using the second pairing strategy.

In some embodiments, as in the example of FIG. 1B, the order in which the pairing strategies are used within a period may change (not shown), even as the duty cycle (percentage of time within the period that a given strategy is used) remains the same. Nevertheless, for periods which are factors or multiples of 60 minutes (e.g., 10 minutes, 30 minutes), periods may always or frequently align to boundaries at the top of each hour (e.g., new periods begin at 9:00, 10:00, 11:00, etc.), regardless of the ordering of pairing strategies to be used for the period at the beginning of a given hour.

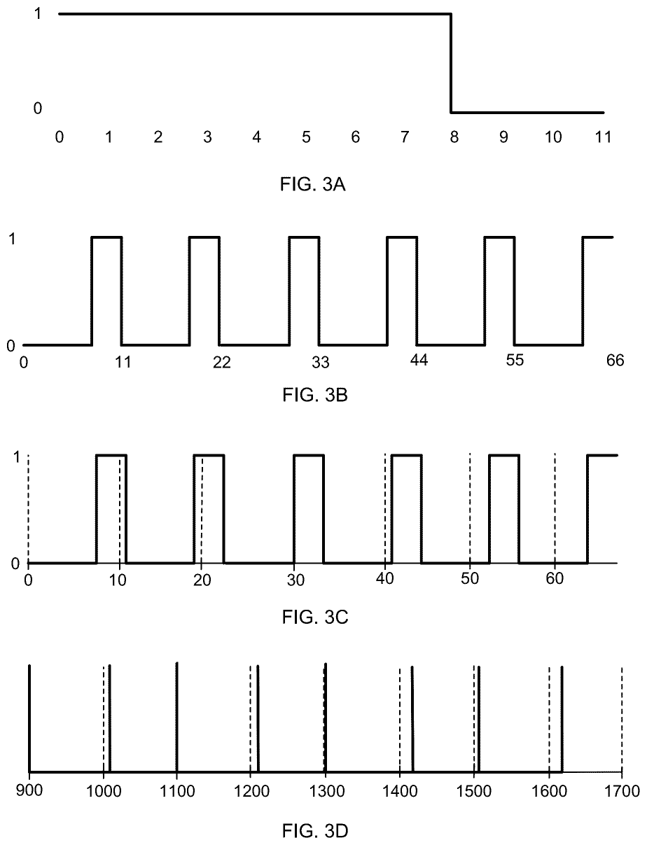

In some embodiments, as explained below with references to FIGS. 3A-D, choosing a period such as 11 minutes, 37 minutes, some prime or other numbers that do not factor into 60-minute intervals, can increase the number of periods required before a particular pattern repeats. Instead, the alignment of periods may drift through hours, days, weeks, etc. before repeating. The duration of a cycle through each pairing strategy may align infrequently with to the hours of a day, days of a week, weeks of a month or year, etc.

FIG. 3A shows an example of a single non-factor period of 11 minutes and approximately a 73% duty cycle, with the first eight minutes using a first pairing strategy and the last three minutes using a second pairing strategy. FIG. 3B illustrates six consecutive cycles. For example, at the top of the first hour on the first day of the week (e.g., Monday at 9:00 AM), the first period may begin, aligned on the top of the hour, the first hour of the day, and the first day of the week. The first period may last from 9:00-9:11 AM, followed by the second period from 9:11-9:22 AM, and so on, as illustrated in FIG. 3B and Table I below. The sixth period begins at 9:55 and ends at 10:06. The top of the second hour (10:00 AM), occurs during the sixth cycle and is not aligned with the beginning of a period. FIG. 3C shows the same six periods as FIG. 3B, with the horizontal axis marking time on ten-minute intervals to illustrate the intentional intra-hour misalignment further.

TABLE I

| Period # | Time Period Begins |
|---|---|
| 1 | 9:00 |
| 2 | 9:11 |
| 3 | 9:22 |
| 4 | 9:33 |
| 5 | 9:44 |
| 6 | 9:55 |
| 7 | 10:06 |

As shown in FIG. 3D and Table II below, the alignment of periods with respect to the nearest hour continues to drift throughout a day, using an example of a contact center open from 9:00 AM to 5:00 PM (9:00-17:00 hours). The first period of the first hour (9:00 AM) is aligned with the top of the hour (9:00 AM). The first period of the second hour (10:00 AM) begins at 10:06 AM, six minutes after the top of the hour. The first period of the third hour (11:00 AM) begins at 11:01 AM, one minute after the top of the hour. It would take 60 periods over 11 hours for the first period of an hour to once again align with the top of the hour. As shown in Table II, a contact center that is open from 9-5 would not be aligned on the hour again until 12:00 PM the following day (1.375 eight-hour days later).

TABLE II

| Hour | Time of First Period of Hour |
|---|---|
| 1 | 9:00 |
| 2 | 10:06 |
| 3 | 11:01 |
| 4 | 12:07 |
| 5 | 13:02 |
| 6 | 14:08 |
| 7 | 15:03 |
| 8 | 16:09 |

Next Day

| | |
|---|---|
| 9 | 9:04 |
| 10 | 10:10 |
| 11 | 11:05 |
| 12 | 12:00 |

Table III below shows the sequence of days and times at which a new period begins at the top of the hour. For example, assuming five-day weeks Monday-Friday with eight-hour days from 9-5, the sequence would proceed from aligning on Monday at 9:00 AM, to Tuesday at 12:00 PM, to Wednesday at 3:00 PM (15:00), to Friday at 10:00 AM, and so on. As shown in Table III, it would take 2.2 weeks for a contact center that is open five days per week for eight hours per day to be aligned at the beginning of a day (e.g., Tuesday at 9:00 AM over two weeks later).

TABLE III

| Day | Next Time Period Starts at Top of Hour |
|---|---|
| Monday | 9:00 |
| Tuesday | 12:00 |
| Wednesday | 15:00 |
| Friday | 10:00 |

Next Week

| | |
|---|---|
| Monday | 13:00 |
| Tuesday | 16:00 |
| Thursday | 11:00 |
| Friday | 14:00 |

Next Week

| | |
|---|---|
| Tuesday | 9:00 |

Table IV below shows the sequence of days of the week on which a new period begins at the top of that day of the week. In this example, assuming five-day weeks Monday-Friday with eight-hour days, the sequence would proceed from aligning with the beginning of the day on Monday in week 1, Tuesday in week 3, Wednesday in week 5, and so on. As shown in Table IV, it would take 11 weeks for this contact center to be aligned at the beginning of a Monday again.

TABLE IV

| Week | Next Day Cycle Starts at Top of Day |
|---|---|
| 1 | Monday |
| 3 | Tuesday |
| 5 | Wednesday |
| 7 | Thursday |
| 9 | Friday |
| 12 | Monday |

Thus, as FIGS. 3A-3D and Tables I-IV have illustrated, selecting a non-factor period for an hour/day/week/etc. boundary may be effective for enabling the alignment of periods to “drift” through natural time boundaries over weeks/months/years. Because the alignment of periods drifts, it is less likely for a pattern to arise that confounds measuring relative performance of multiple pairing strategies. In some embodiments, selection of a non-factor period may be combined with other techniques for reducing the effect of confounding variables on performance, such as randomizing or otherwise changing the ordering of pairing strategies within each period or a set of periods.

In some embodiments, the contact center may determine which pairing strategy to use based on the time at which a pairing request is made for a contact. For example, assume a contact center is benchmarking BP and FIFO using the example of FIG. 1A (ten-minute periods with a 50% duty cycle, starting with BP in the first half and FIFO in the second half). If the contact center requests a pairing at 9:04 AM, the time of the pairing falls in the first half of a period, so the BP strategy may be used. If the contact center requests a pairing at 9:06 AM, the time of the pairing falls in the second half of the period, so the FIFO strategy may be used.

In other embodiments, the contact center may determine which pairing strategy to use based on the time at which a contact arrives. For example, assume a contact center is benchmarking BP and FIFO as in the preceding example. If the first contact arrives at 9:04 AM, the time of arrival falls in the first half of a period, so the BP strategy may be used for the contact. Even if the first contact must wait in a queue for two minutes, and the pairing is not requested until 9:06 AM, the pairing may still be made using the BP strategy. Moreover, if a second contact arrives at 9:05 AM, while the first contact is still waiting in queue, the second contact may be designated for FIFO pairing. Consequently, at 9:06 AM, contact choice under behavioral pairing may be limited to only the contacts in queue who arrived during the BP portion of the period and, in this example, only the first contact to arrive would be available.

In embodiments for epoch-based benchmarking in which a contact arrives on a boundary between periods, or on a boundary between switching pairing strategies within a period, the system may have predetermined tie-breaking strategies. For example, the boundary may be defined as “at or before” an aforementioned time, or “on or after” an aforementioned time, etc. For example, if a period is defined to be associated with strategy “A” from 9:00-9:08 and strategy B from 9:08-9:10, it may mean that a contact must arrive on or after 9:00 but before 9:08 (e.g., 9:07.99) to be considered within the first part of the period. Alternatively, it may mean that a contact must arrive after 9:00 but at or before 9:08.00 to be considered within the first part of the period.

In some embodiments, inline benchmarking techniques may be used, in which pairing strategies may be selected on a contact-by-contact basis. For example, assume that approximately 50% of contacts arriving at a contact center should be paired using a first pairing method (e.g., FIFO), and the other 50% of contacts should be paired using a second pairing method (e.g., BP).

In some embodiments, each contact may be randomly designated for pairing using one method or the other with a 50% probability. In other embodiments, contacts may be sequentially designated according to a particular period. For example, the first five (or ten, or twenty, etc.) contacts may be designated for a FIFO strategy, and the next five (or ten, or twenty, etc.) may be designated for a BP strategy. Other percentages and proportions may also be used, such as 60% (or 80%, etc.) paired with a BP strategy and the other 40% (or 20%, etc.) paired with a FIFO strategy.

From time to time, a contact may return to a contact center (e.g., call back) multiple times. In particular, some contacts may require multiple “touches” (e.g., multiple interactions with one or more contact center agents) to resolve an issue. In these cases, it may be desirable to ensure that a contact is paired using the same pairing strategy each time the contact returns to the contact center. If the same pairing strategy is used for each touch, then the benchmarking technique will ensure that this single pairing strategy is associated with the final outcome (e.g., resolution) of the multiple contact-agent interactions. In other situations, it may be desirable to switch pairing strategies each time a contact returns to the contact center, so that each pairing strategy may have an equal chance to be used during the pairing that resolves the contact's needs and produces the final outcome. In yet other situations, it may be desirable to select pairing strategies without regard to whether a contact has contacted the contact center about the same issue multiple times.

In some embodiments, the determination of whether a repeat contact should be designated for the same (or different) pairing strategy may depend on other factors. For example, there may be a time limit, such that the contact must return to the contact center within a specified time period for prior pairing strategies to be considered (e.g., within an hour, within a day, within a week). In other embodiments, the pairing strategy used in the first interaction may be considered regardless of how much time has passed since the first interaction.

For another example, repeat contact may be limited to specific skill queues or customer needs. Consider a contact who called a contact center and requested to speak to a customer service agent regarding the contact's bill. The contact hangs up and then calls back a few minutes later and requests to speak to a technical support agent regarding the contact's technical difficulties. In this case, the second call may be considered a new issue rather than a second “touch” regarding the billing issue. In this second call, it may be determined that the pairing strategy used in the first call is irrelevant to the second call. In other embodiments, the pairing strategy used in the first call may be considered regardless of why the contact has returned to the contact center.

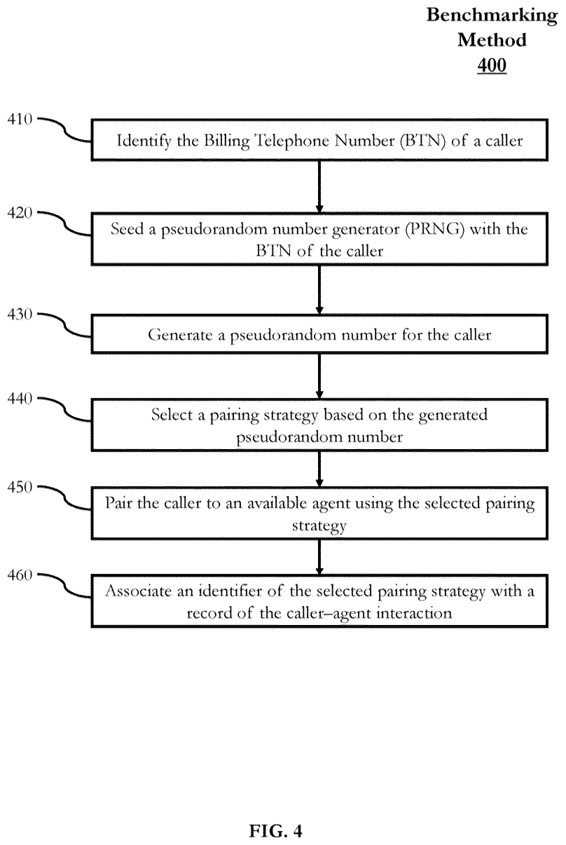

One approach to considering prior pairing for inline benchmarking techniques is depicted in FIG. 4. FIG. 4 shows a flow diagram of benchmarking method 400 according to embodiments of the present disclosure. Benchmarking method 400 may begin at block 410.

At block 410, an identifier of a contact (e.g., caller) may be identified or otherwise determined. In this example, a caller's “Billing Telephone Number” or “BTN” may be identified. This example assumes that a caller uses the same BTN for each call. In other embodiments, other identifiers of the contact (e.g., a customer identification number, Internet Protocol (IP) address) may be used instead. Having identified the caller's BTN (or other contact identifier), benchmarking method 400 may proceed to block 420.

At block 420, a pseudorandom number generator (PRNG) may be seeded with the BTN (or other contact identifier). Having seeded the PRNG with the BTN, benchmarking method 400 may proceed to block 430.

At block 430, a pseudorandom number may be generated for the contact using the seeded PRNG. Because the seed will be the same for a given contact each time the contact returns to the contact center, the generated pseudorandom number will also be the same each time for the given contact. Having generated the pseudorandom number, benchmarking method 400 may proceed to block 440.

At block 440, a pairing strategy (e.g., BP or FIFO) may be selected for the given contact based on the generated pseudorandom number. For example, if 50% of contacts should be paired using BP, and the other 50% should be paired using FIFO, the PRNG may be configured to generate either a 1 or a 0. If the generated pseudorandom number is a 1, the contact may be designated for BP pairing. If the generated pseudorandom number is 0, the contact may be designated for FIFO pairing.

In this way, the contact will always be paired using the same strategy each time the contact returns to the contact center. The PRNG will be seeded with the same seed (e.g., the contact's BTN) each time, so the PRNG will generate the same pseudorandom number for the contact each time. Thus, benchmarking method 400 may select the same pairing strategy for the contact each time. In this way, it is possible to account for prior pairings without relying on a database or other storage means to determine whether or how a contact has been previously paired. In this way, benchmarking method 400 is stateless with respect to whether or how a contact has been previously paired. Having selected a pairing strategy for the contact, benchmarking method 400 may proceed to block 450.

At block 450, the contact may be paired to an available agent using the selected pairing strategy. When a contact has been paired with an available agent, components of the contact center system (e.g., switches, routers) may connect the contact to the agent. Following (or during) the contact-agent interaction, the agent may create a record of the outcome of the interaction. For example, in a sales queue, the agent may create an order for the contact. In a technical support queue, the agent may create or modify a service ticket. The contact center system may also record information about the interaction, such as the time and duration of a call, the BTN or other identifier of the contact, the agent identifier, and other data. At this point, benchmarking method may proceed to block 460.

At block 460, an identifier of the selected pairing strategy may be associated with the record of the contact-agent interaction created at block 450. In some embodiments, this may happen simultaneously with the creation of the record. For example, when the contact center system records the time and duration of a call, it may also record whether the call had been paired using a BP or FIFO pairing strategy. In other embodiments, another module may create a separate record of the pairing. This module may record the time of the pairing, the contact and agent identifiers, the pairing strategy used (e.g., BP or FIFO), and any other data that may be helpful for later matching the pairing record with the record of the caller-agent interaction outcome. At some later time, the pairing records may be matched with the caller-agent interaction records so that the pairing strategy information may be associated with the outcome in one record or the other (or both). Following block 460, benchmarking method 400 may end. In some embodiments, benchmarking method 400 may return to block 410, waiting for another contact to arrive.

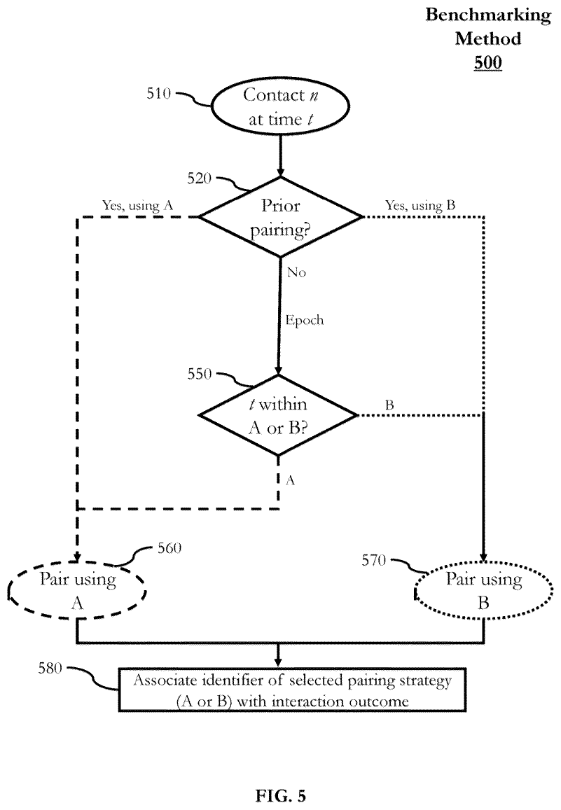

Another approach to considering prior pairing in combination with epoch benchmarking techniques is depicted in FIG. 5. This type of technique may be considered “hybrid inline-epoch benchmarking.” FIG. 5 shows a flow diagram of benchmarking method 500 according to embodiments of the present disclosure. Benchmarking method 500 may begin at block 510.

At block 510, a contact (e.g., “contact n”) arrives at the contact center at a particular time t. Benchmarking method 500 may proceed to block 520.

At block 520, it may be determined whether the contact has been previously paired; i.e., whether this contact is returning to the contact center for a subsequent touch or interaction. This decision may be made using a variety of techniques. For example, the benchmarking system may look up the contact's records using a contact identifier (e.g., BTN or customer ID) in a database to determine whether and when the contact had previously contacted the contact center. Using a suitable technique, the benchmarking system may determine that the contact had been previously paired and, in some embodiments, whether and how the prior pairing should influence the current pairing.

In some embodiments, the benchmarking system may preferably pair a contact using the same pairing strategy every time the contact returns to the contact center. Thus, if contact n was previously paired using pairing strategy “A” (e.g., BP), benchmarking method 500 may proceed to block 560 for subsequent pairing using pairing strategy A again. Similarly, if contact n was previously paired using pairing strategy “B”) (e.g., FIFO), benchmarking method 500 may proceed to block 570 for subsequent pairing using pairing strategy B again.

However, if it is determined at block 520 that contact n has not been previously paired (or, in some embodiments, any prior pairing should not influence the current pairing), benchmarking method 500 may proceed to using epoch benchmarking at block 550.

At block 550, time may be used to determine which pairing strategy to use for contact n. In this example, arrival time t may be used. If contact n arrived during a time period when the benchmarking system is pairing using strategy A, benchmarking method 500 may proceed to block 560 for subsequent pairing using strategy A. Similarly, if contact n arrived during a time period when the benchmarking system is pairing using strategy B, benchmarking method 500 may proceed to block 570 for subsequent pairing using strategy B.

At blocks 560 and 570, contacts may be paired to available agents using pairing strategies A or B, respectively. In some embodiments, more than two pairing strategies may be used (e.g., prior pairings using A, B, C, etc. or epoch benchmarking within time periods using A, B, C, etc.). Once paired, the contact may be routed or otherwise connected to the available agent within the contact center system. As described above with respect to benchmarking method 400 (FIG. 4), the agent may create a record of the contact-agent interaction, and the contact center system may also create or modify this record. Benchmarking method may proceed to block 580.

At block 580, an identifier to the selected pairing strategy (e.g., A or B) may be associated with the record created at block 560 or 570. As described above with respect to benchmarking method 400, this association may occur simultaneously with the creation of the contact-agent interaction record, or it may be matched at a later time with other records created by a benchmarking module or other module. Following block 580, benchmarking method 500 may end. In some embodiments, benchmarking method 500 may return to block 510, waiting for another contact to arrive.

By associating the pairing strategy with the outcome as in, for example, benchmarking methods 400 and 500, the outcomes associated with each pairing strategy may be measured (e.g., averaged, accumulated), and the relative performance of each pairing strategy may be measured (e.g., the relative overall performance gain attributable to pairing using BP instead of pairing using FIFO). This benchmarking data may be used for a variety of purposes. For example, the data may be used to assess the strength of one pairing module over another. For another example, the data may be used to improve the strength of a BP module by providing “BP on” and “BP off” (e.g., FIFO) contact-agent interaction records to enhance the artificial intelligence in the system. For another example, the data may be used for billing. Because the value added by one pairing strategy over another may be measured accurately and fairly, this benchmarking data may be used in a pay-for-performance business model, in which a client pays a pairing strategy vendor a percentage of the actual measured value added by using the vendor's pairing strategy (e.g., when BP is on as opposed to when BP is off).

Specifically, in some embodiments, associated outcome data may be used to determine an economic value or gain associated with using one pairing strategy instead of another. In some embodiments, the economic value or gain may be used to determine compensation for a vendor or other service provider providing a module or modules for the higher-performing pairing strategy creating the economic value. For example, if a contact center benchmarks BP against FIFO and determines that, for a given time period (e.g., a day, a week, a month, etc.), that BP performed 5% better than FIFO on average over the time period, the BP vendor may receive compensation corresponding to the 5% value added by BP (e.g., a percentage of the 5% additional sales revenue, or a percentage of the 5% additional cost savings, etc.). Under such a business model, a contact center owner may forgo capital expenditure or vendor fees, only paying a vendor for periods of time in which the vendor demonstrates value added to the contact center's performance.

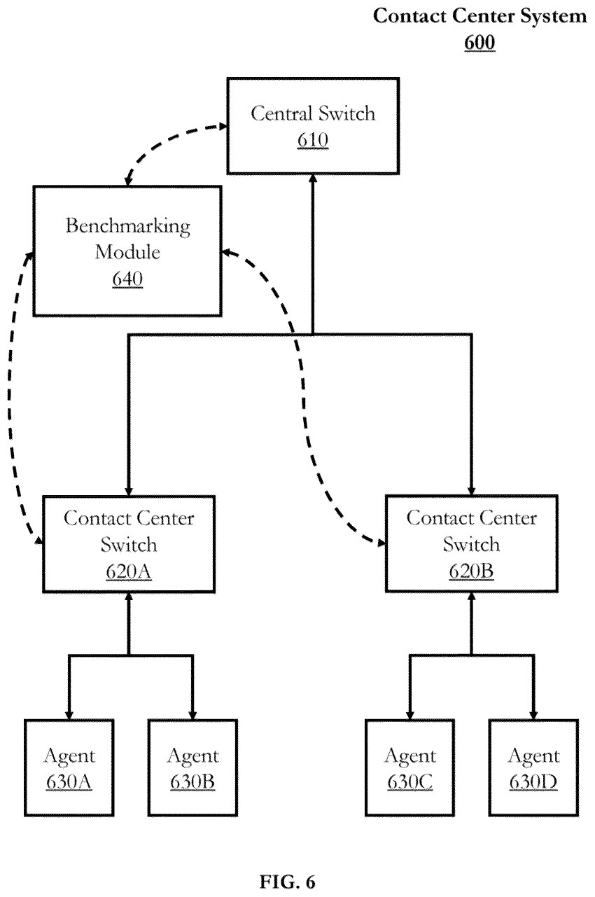

FIG. 6 shows a block diagram of a contact center system 600 according to embodiments of the present disclosure. The description herein describes network elements, computers, and/or components of a system and method for simulating contact center systems that may include one or more modules. As used herein, the term “module” may be understood to refer to computing software, firmware, hardware, and/or various combinations thereof. Modules, however, are not to be interpreted as software which is not implemented on hardware, firmware, or recorded on a processor readable recordable storage medium (i.e., modules are not software per se). It is noted that the modules are exemplary. The modules may be combined, integrated, separated, and/or duplicated to support various applications. Also, a function described herein as being performed at a particular module may be performed at one or more other modules and/or by one or more other devices instead of or in addition to the function performed at the particular module. Further, the modules may be implemented across multiple devices and/or other components local or remote to one another. Additionally, the modules may be moved from one device and added to another device, and/or may be included in both devices.

As shown in FIG. 6, the contact center system 600 may include a central switch 610. The central switch 610 may receive incoming contacts (e.g., callers) or support outbound connections to contacts via a telecommunications network (not shown). The central switch 610 may include contact routing hardware and software for helping to route contacts among one or more contact centers, or to one or more PBX/ACDs or other queuing or switching components within a contact center.

The central switch 610 may not be necessary if there is only one contact center, or if there is only one PBX/ACD routing component, in the contact center system 600. If more than one contact center is part of the contact center system 600, each contact center may include at least one contact center switch (e.g., contact center switches 620A and 620B). The contact center switches 620A and 620B may be communicatively coupled to the central switch 610.

Each contact center switch for each contact center may be communicatively coupled to a plurality (or “pool”) of agents. Each contact center switch may support a certain number of agents (or “seats”) to be logged in at one time. At any given time, a logged-in agent may be available and waiting to be connected to a contact, or the logged-in agent may be unavailable for any of a number of reasons, such as being connected to another contact, performing certain post-call functions such as logging information about the call, or taking a break.

In the example of FIG. 6, the central switch 610 routes contacts to one of two contact centers via contact center switch 620A and contact center switch 620B, respectively. Each of the contact center switches 620A and 620B are shown with two agents each. Agents 630A and 630B may be logged into contact center switch 620A, and agents 630C and 630D may be logged into contact center switch 620B.

The contact center system 600 may also be communicatively coupled to an integrated service from, for example, a third party vendor. In the example of FIG. 6, benchmarking module 640 may be communicatively coupled to one or more switches in the switch system of the contact center system 600, such as central switch 610, contact center switch 620A, or contact center switch 620B. In some embodiments, switches of the contact center system 600 may be communicatively coupled to multiple benchmarking modules. In some embodiments, benchmarking module 640 may be embedded within a component of a contact center system (e.g., embedded in or otherwise integrated with a switch). The benchmarking module 640 may receive information from a switch (e.g., contact center switch 620A) about agents logged into the switch (e.g., agents 630A and 630B) and about incoming contacts via another switch (e.g., central switch 610) or, in some embodiments, from a network (e.g., the Internet or a telecommunications network) (not shown).

A contact center may include multiple pairing modules (e.g., a BP module and a FIFO module) (not shown), and one or more pairing modules may be provided by one or more different vendors. In some embodiments, one or more pairing modules may be components of benchmarking module 640 or one or more switches such as central switch 610 or contact center switches 620A and 620B. In some embodiments, a benchmarking module may determine which pairing module may handle pairing for a particular contact. For example, the benchmarking module may alternate between enabling pairing via the BP module and enabling pairing with the FIFO module. In other embodiments, one pairing module (e.g., the BP module) may be configured to emulate other pairing strategies. For example, a benchmarking module, or a benchmarking component integrated with BP components in the BP module, may determine whether the BP module may use BP pairing or emulated FIFO pairing for a particular contact. In this case, “BP on” may refer to times when the BP module is applying the BP pairing strategy, and “BP off” may refer to other times when the BP module is applying a different pairing strategy (e.g., FIFO).

In some embodiments, regardless of whether pairing strategies are handled by separate modules, or if some pairing strategies are emulated within a single pairing module, the single pairing module may be configured to monitor and store information about pairings made under any or all pairing strategies. For example, a BP module may observe and record data about FIFO pairings made by a FIFO module, or the BP module may observe and record data about emulated FIFO pairings made by a BP module operating in FIFO emulation mode.

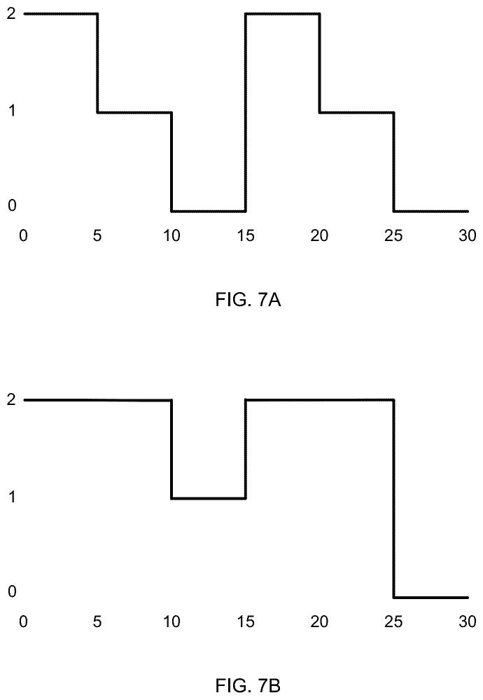

Embodiments of the present disclosure are not limited to benchmarking only two pairing strategies. Instead, benchmarking may be performed for two or more pairing strategies. FIGS. 7A and 7B depict examples of benchmarking systems for three pairing strategies (e.g., benchmarking FIFO, PBR, and BP).

FIG. 7A shows a schematic representation of benchmarking sequence according to embodiments of the present disclosure. In this epoch benchmarking example, a period is 15 units of time, and each pairing strategy is used for one-third of the time (5 units). FIG. 7A shows two complete periods, cycling among pairing strategies “2”, “1”, and “0” twice over 30 units of time. For example, from 9:00-9:10 AM, FIFO may be used; from 9:10-9:20 AM, PBR may be used; and from 9:20-9:30 AM, BP may be used. This pattern of FIFO-PBR-BP repeats in the second period.

FIG. 7B shows a schematic representation of benchmarking sequence according to embodiments of the present disclosure. In this epoch benchmarking example, a complete period is 30 time units. A preferred pairing strategy “2” (e.g., BP) is used two-thirds of the time, and other pairing strategies “1” and “0” (e.g., FIFO and PBR) are used one-sixth of the time each. In this example, each time strategy “2” turns off, pairing strategies “1” and “0” alternately turn on. For example, the pattern may be BP-FIFO-BP-PBR. In addition to the examples of FIGS. 7A and 7B, many other patterns for switching among multiple pairing strategies are possible.

In some embodiments, contact center management or other users may prefer a “stabilization period” or other neutral zone. For example, consider a contact center benchmarking BP and FIFO pairing strategies. When the system transitions from BP to FIFO (or vice versa), contact center management may be concerned that the effects of one pairing strategy may somehow influence the performance of another pairing strategy. To alleviate these concerns about fairness, a stabilization period may be added.

One technique for implementing a stabilization period may be to exclude contact-agent interaction outcomes for the first portion of contacts after switching pairing strategies. For example, assume a contact center is benchmarking BP and FIFO with a 50% duty cycle over 30-minute periods. In the aforementioned embodiments (e.g., FIGS. 1A and 1B), BP would be on for 15 minutes, followed by FIFO for 15 minutes, and all of the contact-agent interactions in the 30-minute period would be included in the benchmarking measurement. With a stabilization period, BP would be on for, e.g., 10 minutes. After 10 minutes, the system would switch to FIFO. However, the first, e.g., 10 minutes would be considered a stabilization period, and FIFO pairings made during this period would be excluded from the benchmark. The last 10 minutes of the period would continue pairing using FIFO, and these FIFO pairings would be included in the benchmark.

This pattern is illustrated in FIG. 7A. In this example, instead of depicting switching among three pairing strategies “2”, “1”, and “0”, the “1” may represent the stabilization period. Pairing strategy “2” (e.g., BP) may be on for the first five time units. After five time units, BP may be switched off, and the other pairing strategy (e.g., FIFO) may be used for the remaining ten time units. The next five units (“1”) may be excluded as being part of the stabilization period, and the five time units after that (“0”) may be included as being part of the FIFO benchmarking period.

In some embodiments, the stabilization period may be longer or shorter. In some embodiments, a stabilization period may be used in a FIFO-to-BP transition instead of, or in addition to, a BP-to-FIFO transition (or any transition between two different pairing strategies).

As noted above, some contacts may require multiple “touches” (e.g., multiple interactions with one or more contact center agents) to resolve the contact's needs. For example, an individual may call or otherwise contact a mortgage bank several times. The first call may be merely introductory or informational in nature, the second call may be to evaluate different loan offers, and the third call may be to close (accept) or decline a loan offer. Similarly, some technical support and customer service requests may require more than one contact interaction to resolve.

In some situations, it may be desirable to select pairing strategies without regard to whether a contact has contacted the contact center about the same issue multiple times. Instead, the benchmarking technique may be configured to account for each pairing strategy. For example, each pairing strategy may be credited in a manner that fairly accounts for the extent to which it may have contributed to the series of contact interactions that resulted in a final outcome or resolution of the contact's needs.

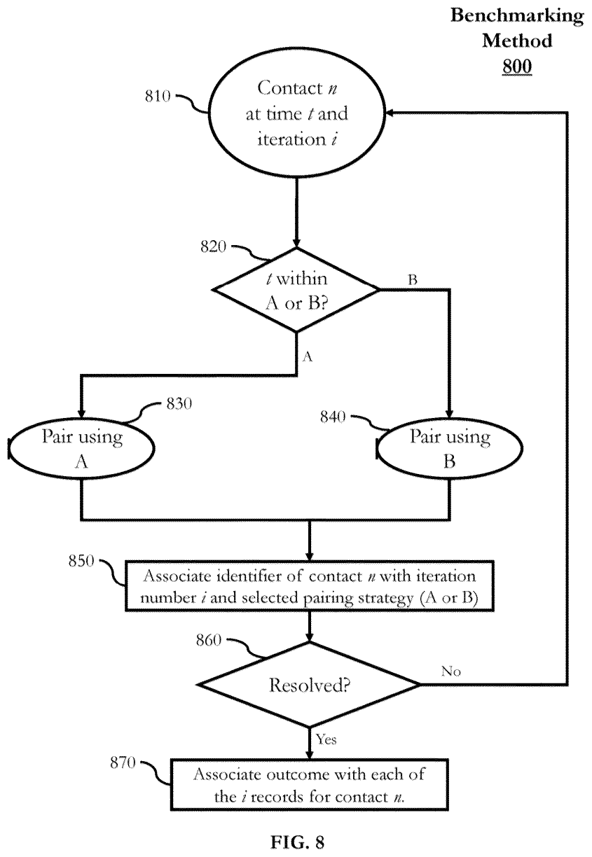

FIG. 8 shows a flow diagram of benchmarking method 800 according to embodiments of the present disclosure. Benchmarking method 800 may begin at block 810.

At block 810, a contact (e.g., “contact n”) arrives at the contact center at a particular time t and a particular iteration i. For example, if this time is the first time contact n has contacted the contact center about this particular need, it will be designated the first iteration (i.e., i=1), or this time may be the second (i=2), third (i=3), . . . i^{th} time calling. Benchmarking method 800 may proceed to block 820.

At block 820, time may be used to determine which pairing strategy to use for contact n. In these embodiments, even if this is a subsequent arrival such that i>1, the pairing strategy selected for any prior pairing need not influence the current pairing. In this example, arrival time t may be used. If contact n arrived during a time period when the benchmarking system is pairing using strategy A, benchmarking method 800 may proceed to block 830 for subsequent pairing using strategy A. Similarly, if contact n arrived during a time period when the benchmarking system is pairing using strategy B, benchmarking method 800 may proceed to block 840 for subsequent pairing using strategy B. In some embodiments, pairing strategy A may be a behavioral pairing strategy (behavioral pairing “ON”), and pairing strategy B may be a different pairing strategy such as FIFO or performance-based routing (behavioral pairing “OFF”).

At blocks 830 and 840, contacts may be paired to available agents using pairing strategies A or B, respectively. In some embodiments, more than two pairing strategies may be used. Once paired, the contact may be routed or otherwise connected to the available agent within the contact center system. As described above with respect to benchmarking methods 400 (FIG. 4) and 500 (FIG. 5), the agent may create a record of the contact-agent interaction, and the contact center system may also create or modify this record. Benchmarking method may proceed to block 850.

At block 850, an identifier to the selected pairing strategy (e.g., A or B) may be associated with an identifier of the current iteration i for the contact n within the record (or set of records) created at block 830 or 840. As described above with respect to benchmarking methods 400 and 500, this association may occur simultaneously with the creation of the contact-agent interaction record, or it may be matched at a later time with other records created by a benchmarking module or other module.

In some embodiments, benchmarking method 800 may proceed to block 860. At block 860, it may be determined whether the needs of contact n have been resolved. If the needs of contact n have not yet been resolved, or in other embodiments where the outcome of a given call may be matched at a later time, benchmarking method 800 may end or return to block 810 for the next contact to arrive. If the needs of contact n have been resolved, benchmarking method 800 may proceed to block 870.

At block 870, the final outcome (e.g., a mortgage loan was closed or declined, a sale was completed or canceled) may be associated with the record or records for each of the i iterations for contact n. Table V shows an example set of records for four contacts W, X, Y, and Z, who each contacted the contact center system three times before reaching a final resolution. In real-world scenarios, there may be many more contacts, and the number of contact interactions needed to resolve an individual contact's needs may vary from one contact to the next, ranging from just one contact interaction to three or even more.

TABLE V

| Iteration i | Contact W | Contact X | Contact Y | Contact Z |
|---|---|---|---|---|
| 1 | A | B | A | B |
| 2 | B | B | A | A |
| 3 | A | A | B | B |
| Outcome | Sale | Sale | Sale | No Sale |

As shown in Table V, and as described above with respect to block 850, the identifiers for the contact (W, X, Y, or Z) and the iteration (1, 2, or 3) are associated with the selected pairing strategy used for the given contact interaction (A or B). For contact W, iteration 1 was paired with strategy A, iteration 2 was paired with strategy B, and iteration 3 was paired with strategy A. For contact X, iteration 1 was paired with strategy B, iteration 2 was paired with strategy B, and iteration 3 was paired with strategy A. For contact Y, iteration 1 was paired with strategy A, iteration 2 was paired with strategy A, and iteration 3 was paired with strategy B. For contact Z, iteration 1 was paired with strategy B, iteration 2 was paired with strategy A, and iteration 3 was paired with strategy B.

Also shown in Table V, and as described above with respect to block 870, the final outcome for the contact may be associated with the records for each iteration. Contacts W, X, and Y completed sales. Contact Z did not complete a sale. In some embodiments, a “no sale” determination may be made if the contact explicitly states that it does not intend to complete a sale. In other embodiments, the contact center system may make a “no sale” determination after a predetermined number of iterations have occurred without completing a sale, or after a predetermined amount of time has passed since the most recent iteration without completing a sale. In some situations, such as when a contact has resolved a technical support or customer service need, the final resolution may be a customer satisfaction survey result or score.

Following block 870, benchmarking method 800 may end. In some embodiments, benchmarking method 800 may return to block 810, waiting for another contact to arrive (e.g., a different contact, or contact n with a new need).

On a continuous, hourly, daily, weekly, etc. basis, a difference in performance among pairing strategies may be determined. In some embodiments, the performance difference may be stratified for each iteration (the performance difference for all contact interactions of iteration i=1; all contact interactions of iteration i=2; etc.). Although a final resolution may not have been reached after the first contact interaction (when i=1), the benchmark for the first stratum may be measured using the final outcome, which was previously associated with that first contact interaction either at block 870 or matched at a later time with other contact center system records.

Using the example shown in Table V, for the benchmark for the first stratum (i=1), two contacts (W and Y) were paired using strategy A for the first iteration, and both had final outcomes resulting in a sale, achieving a conversion rate of 100%. The other two contacts (X and Z) were paired using strategy B for the first iteration, and only one (X) had a final outcome resulting in a sale, achieving a conversation rate of 50%.

Similarly, for the benchmark for the second stratum (i=2), two contacts (Y and Z) were paired using strategy A for the second iteration, and only one (Y) had a final outcome resulting in a sale, achieving a conversation rate of 50%. The other two contacts (W and X) were paired using strategy B for the second iteration, and both had final outcomes resulting in a sale, achieving a conversion rate of 100%.

Finally, for the benchmark for the third stratum (i=3), two contacts (W and X) were paired using strategy A for the third iteration, and both had final outcomes resulting in a sale, achieving a conversion rate of 100%. The other two contacts (Y and Z) were paired using strategy B for the third iteration, and only one (Y) had a final outcome resulting in a sale, achieving a conversion rate of 50%.

These strata and conversion rates are shown in Table VI below:

TABLE VI

| Iteration/Stratum i | Strategy A | Strategy B |
|---|---|---|
| 1 | 100% | 50% |
| 2 | 50% | 100% |
| 3 | 100% | 50% |

After determining performances or performance differences between each pairing strategy for each iteration (based on the final outcomes), the performance differences may be combined. In some embodiments, the performance differences may be averaged. In the example of Table V, the average conversion rate for strategy A is approximately 83%, and the average conversion rate for strategy B is approximately 67%. Strategy A performed almost 24% better than strategy B. In some embodiments, the performance differences may be normalized based on the total number of contact interactions for each strategy for each iteration.

In some embodiments, some iterations may be weighted more or less than other iterations. For example, it may be determined (by, e.g., contact center system administrators or other business leaders) that the first contact interaction is the most critical to determining whether or to what extent a desirable final outcome will be achieved. In other situations, it may be determined that the final contact interaction is the most critical. In these situations, the more critical strata may be weighted more heavily than less critical strata in the final benchmarking result.

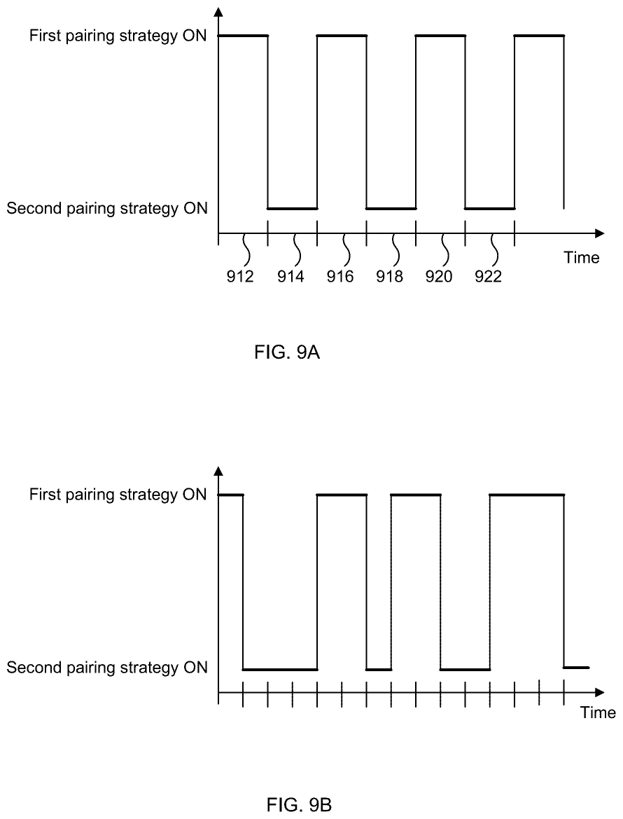

As discussed above, in benchmarking the performance of different pairing strategies, the epoch benchmarking described above may be used in some embodiments. As shown in FIG. 9A, in case the epoch benchmarking is used for evaluating the performance of first and second pairing strategies, the first pairing strategy (PS) and the second PS are employed alternatively for predefined time intervals. That is, the first PS is exclusively employed during a first predefined interval of time (e.g., 10 min), then, at the expiration of the first period of time, the second PS is employed exclusively for a second predefined interval of time (e.g., 10 min, 20 min, 30 min) and this cycle repeats as shown in FIG. 9A. More specifically, as shown in FIG. 9A, the first PS is exclusively employed during time intervals 912, 916, and 920 and the second PS is exclusively employed during time intervals 914, 918, and 922. In the example shown, time intervals 912, 916, and 920 have the same duration as time intervals 914, 918, and 922, respectively, but this is not a requirement.

On the other hand, as shown in FIG. 9B, in case the inline benchmarking is used for evaluating the performance of first and second PSs, the PSs are employed in a random manner.

For example, for each pairing opportunity, a pseudorandom number generator may be used to generate a pseudo random number (PRN) based on a seed value (e.g., time of day in seconds) and the PRN is used to determine whether to employ the first pairing strategy or the second pairing strategy for the given pairing opportunity.

In embodiments where more than two PSs need to be evaluated, a combination of benchmarking techniques (a.k.a., a hybrid benchmarking) may be used to evaluate the different pairing strategies. For example, the epoch benchmarking and the inline benchmarking may be used together to evaluate the performance of different pairing strategies.

In some embodiments, when hybrid benchmarking is employed, each PS to be evaluated belongs to at least one PS set included in a group of two or more PS sets. For instance, if there are three PSs to be evaluated (a first PS, a second PS, and a third PS), then the first PS (e.g., FIFO) may be a member of PS set 1, the second PS (e.g. 2D BP) may be a member of PS set 2, and the third PS (e.g., 3D BP) may also be a member of PS set 2. Hence a PS set may consist of a single PS or it may comprise two more PSs. Accordingly, as used herein a “PS set” is a single PS or a group of two or more PSs. In this example, epoch benchmarking can be used to select which PS set to employ for any given pairing opportunity, and, if the selected PS set comprises more than one PS, then inline benchmarking can be used to select which one of the PSs included in the selected PS to employ for the given pairing opportunity.

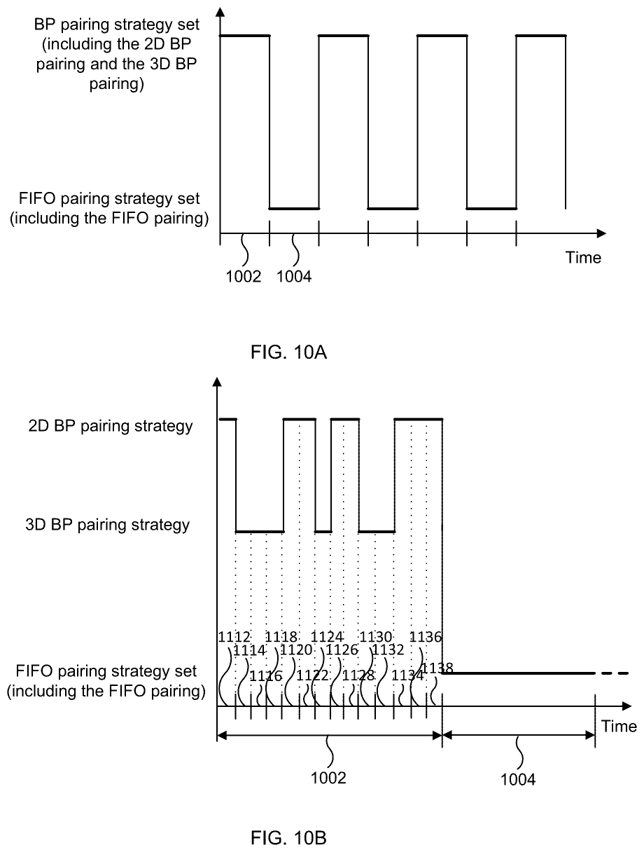

FIG. 10A provides an illustration of hybrid benchmarking in the case where the performance of three different PSs is being evaluated. In FIG. 10A, the pairing strategies are the FIFO, the two-dimensional (“2D”) BP, and the three-dimensional (“3D”) BP. The types of pairing strategies shown in FIG. 10A are provided for explanation purpose only, and do not limit the embodiments of this disclosure in any way.

In 2D BP, a first dimension of the 2D relates to agents and a second dimension of the 2D relates to tasks (e.g., callers). The 2D BP may be used to pair the agents and the tasks. In 3D BP, a first dimension of the 3D relates to agents, a second dimension of the 3D relates to tasks, and a third dimension of the 3D may relate to a set of offer(s) or a rewards. The 3D BP may be used to assign tasks and offers/rewards to the agents. Similarly, in N-dimensional BP, each of the N dimensions relates to a different parameter (e.g., agents, tasks, offers, or rewards) and the N-dimensional BP may be used to assign one of the parameters (e.g., agents) to the rest of the different parameters (e.g., tasks, offers, rewards, etc.). More detailed information about the multi-dimensional BP is provided in the appendix.

As shown in FIG. 10A, the 2D BP and the 3D BP are members of a first PS set (i.e., the BP set) and FIFO is a member of the second PS set, and epoch benchmarking is used to select between the first PS set and the second PS set. For example, during time interval 1002, the first PS set (the BP set) is employed to do the pairings, and during interval 1004 the second PS set (i.e. FIFO) is employed to do the pairings, and this cycle repeats.

Because the BP set includes two different PSs, 2D BP and 3D BP, a second benchmarking (e.g., the inline benchmarking) may be applied during time interval 1002 to select between 2D BP and 3D BP.

For example, as shown in FIG. 10B, inline benchmarking is used to alternate between the 2D BP and the 3D BP during the time interval 1002. For example, for each time interval 1112-1138, a PRN may be generated and then the PRN is used to select whether 2D BP or 3D BP is employed during that time interval.

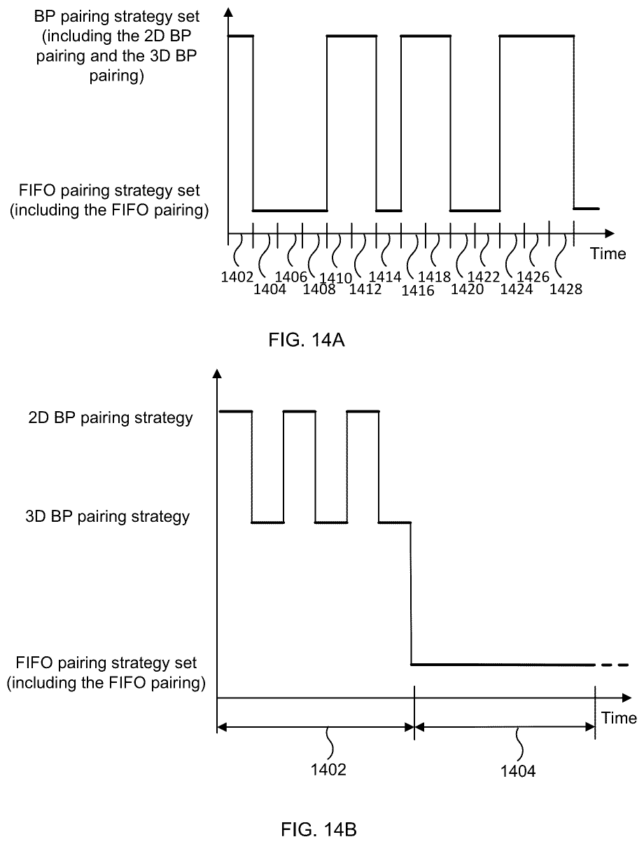

FIG. 14A illustrates another example of hybrid benchmarking in the case where the performance of three different PSs is being evaluated and inline benchmarking is used to select between the first PS set and the second PS set. For example, for each time interval 1402-1428, a PRN is obtained and then used to select between FIFO and the BP set for that time interval (as shown in FIG. 14 A, the FIFO set was choses for 3 consecutive time intervals 1404, 1406, and 1408).

Because the BP set includes two different PSs, 2D BP and 3D BP, in the example shown in FIG. 14B, epoch benchmarking may be applied during time interval 1402 to select between 2D BP and 3D BP.

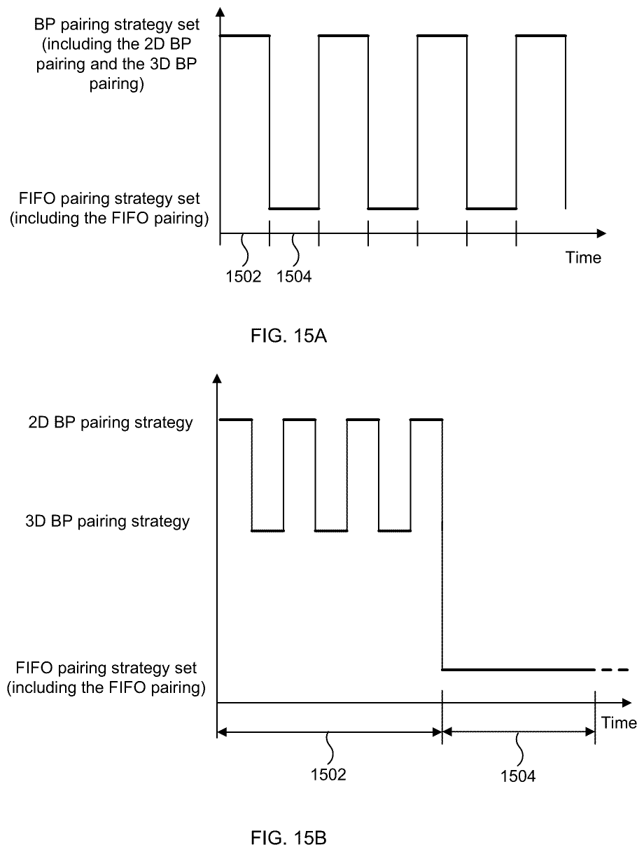

FIG. 15A illustrates another example of hybrid benchmarking in the case where the performance of three different PSs is being evaluated and epoch benchmarking is used to select between the first PS set and the second PS set. For example, during time interval 1502, the first PS set (the BP set) is employed to do the pairings, and during interval 1504 the second PS set (i.e. FIFO) is employed to do the pairings, and this cycle repeats.

Because the BP set includes two different PSs, 2D BP and 3D BP, in the example shown in FIG. 15B, another epoch benchmarking is applied during time interval 1502 to select between 2D BP and 3D BP. The epoch benchmarking used for selecting between the first PS set and the second PS set may be same as or different from the epoch benchmarking used for selecting between 2D BP and 3D BP.

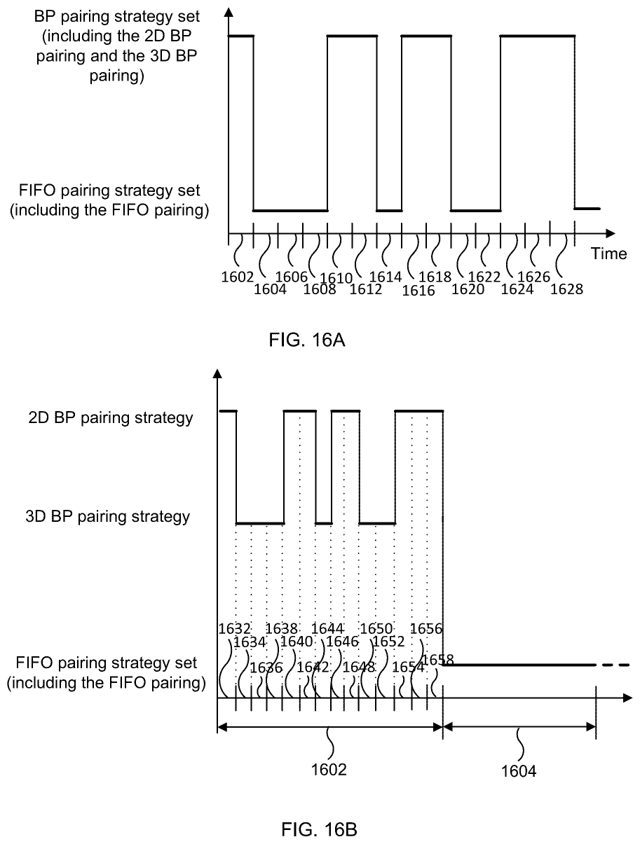

FIG. 16A illustrates another example of hybrid benchmarking in the case where the performance of three different PSs is being evaluated and inline benchmarking is used to select between the first PS set and the second PS set. For example, for each time interval 1602-1628, a PRN is obtained and then used to select between FIFO and the BP set for that time interval (as shown in FIG. 16A, the FIFO set was choses for 3 consecutive time intervals 1604, 1606, and 1608).

Because the BP set includes two different PSs, 2D BP and 3D BP, a second benchmarking (e.g., the inline benchmarking) may be applied during time interval 1602 to select between 2D BP and 3D BP.

For example, as shown in FIG. 16B, inline benchmarking is used to alternate between the 2D BP and the 3D BP during the time interval 1602. For example, for each time interval 1632-1658, a PRN may be generated and then the PRN is used to select whether 2D BP or 3D BP is employed during that time interval.

It is contemplated that any PS set can contain two more PS sets. In such an embodiment, whenever a PS set containing multiple PS sets is selected, then another selection may take place to select one of the PS sets included in the selected PS set. For example, consider a scenario having a group of two PS sets, PS-set-1 and PS-set-2, and that PS-set-2 itself has as its members two PS sets, PS-set-2.1 and PS-set-2.2, and PS-set-2.2 includes two PS sets, PS-set-2.2.1 and PS-set-2.2.2. In this scenario, if PS-set-2 is initially selected then another selection process must take place to select one of PS-set-2.1 or PS-set 2.2. If PS-set-2.2 is selected, then another selection process must take place to select on of PS-set-2.2.1 or PS-set-2.2.2. Likewise, if PS-set-2.2.2 is selected and this set comprise more than on PS set, then yet another selection process may take place to select one of the member of PS-set-2.2.2. Thus PS sets can be nested any amount.

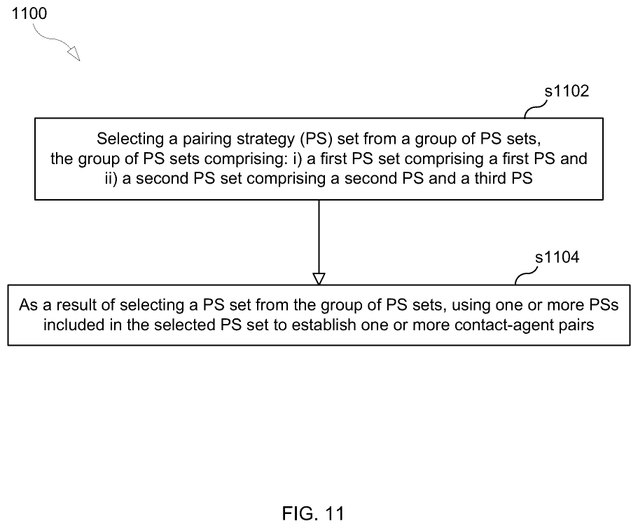

FIG. 11 shows a process 1100 according to some embodiments. Process 1100 may begin with step s1102. Step s1102 comprises selecting a pairing strategy (PS) set from a group of PS sets, the group of PS sets comprising: i) a first PS set comprising a first PS (first pairing algorithm/module) and ii) a second PS set comprising a second PS and a third PS. Step s1104 comprises as a result of selecting a PS set from the group of PS sets, using one or more PSs included in the selected PS set to establish one or more contact-agent pairs.

In some embodiments, selecting a PS set from the group of PS sets comprises: selecting a PS set from the group of PS sets based on a time value indicating a time of day or indicating an amount time that has elapsed since an epoch, or selecting a PS set from the group of PS sets based on a generated pseudo random value (PRV).

In some embodiments, the method further comprises receiving at one or more switches contact information indicating a plurality of contacts available for pairing; and obtaining, by at least one computer processor communicatively coupled to and configured to operate in a contact center system, the contact information indicating the plurality of available contacts, wherein each of the plurality of available contacts is available for pairing to one of a plurality of available agents, wherein the step of using one or more PSs included in the selected PS set to establish one or more contact-agent pairs comprises selecting a PS included in the selected PS set and using the selected PS to pair one of the available contacts with one of the available agents.

In some embodiments, the selected PS set is the second PS set, and selecting a PS included in the second PS set comprises generating a PRV and using the PRV to select a PS included in the second PS set.

In some embodiments, the step of selecting a PS set from the group of PS sets comprises: determining the current time of day; and selecting a PS set include in the group of PS sets based on the determined current time of day.

In some embodiments, the step of using the one or more PS included in the selected PS set to establish one or more contact-agent pairs comprises: for at least a first specified duration of time, using the one or more PSs included in the selected PS set to establish the one or more contact-agent pairs.

In some embodiments, the selected PS set is the second PS set, the first PS set consists of the first PS, and the method further comprises: determining that the first specified duration of time has elapsed; and as a result of determining that the first specified duration of time has elapsed, for at least a second specified duration of time, using the first PS set to establish a plurality of contact-agent pairs.

In some embodiments, the first PS is a first-in-first-out PS, the second PS is a two-dimensional behavioral PS, and the second PS is an n-dimensional behavioral PS, where n>2.

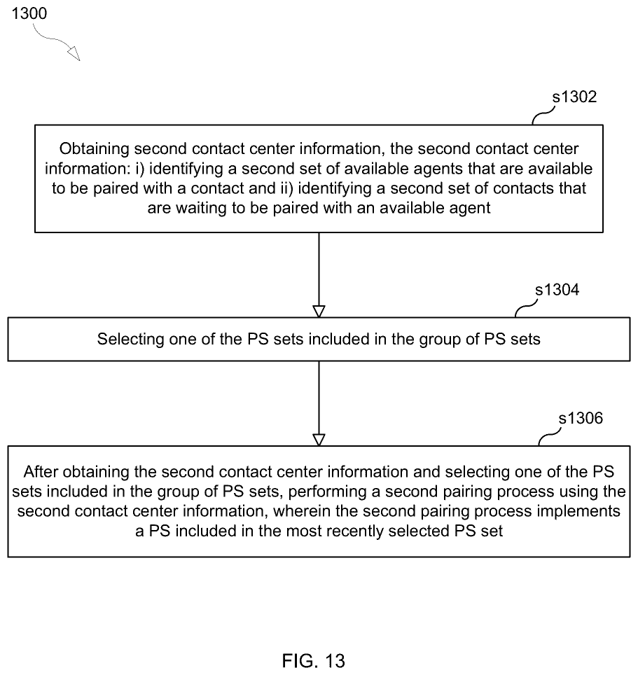

FIG. 13 shows a process 1300 according to some embodiments. Process 1300 may begin with step s1302. Step s1302 comprises obtaining first contact center information, the first contact center information: i) identifying a first set of available agents that are available to be paired with a contact and ii) identifying a first set of contacts that are waiting to be paired with an available agent. Step s1304 comprises selecting a pairing strategy (PS) set from a group of two or more PS sets, the group of PS sets comprising: i) a first PS set comprising a first PS and ii) a second PS set comprising a second PS and a third PS. Step s1306 comprises after obtaining the first contact center information and after selecting the pairing strategy set, performing a first pairing process using the first contact center information, wherein the first pairing process implements a PS included in the selected PS set.

In some embodiments, the method further comprises, after performing the first pairing process: obtaining second contact center information, the second contact center information: i) identifying a second set of available agents that are available to be paired with a contact and ii) identifying a second set of contacts that are waiting to be paired with an available agent; selecting one of the PS sets included in the group of PS sets; and after obtaining the second contact center information and selecting one of the PS sets included in the group of PS sets, performing a second pairing process using the second contact center information, wherein the second pairing process implements a PS included in the most recently selected PS set.

As shown in FIGS. 10A-10B, 14A-14B, 15A-15B, and 16A-16B, in some embodiments, a first group (e.g., the BP PS set in FIG. 15A) of one or more pairing strategies (PSs) is applied during a first time period (e.g., 1502 in FIGS. 15A and 15B) and a second group (e.g., the FIFO PS set in FIGS. 15A and 15B) of one or more PSs is applied during a second time period (e.g., 1504 in FIGS. 15A and 15B) that is subsequent to the first time period. Note that even though FIGS. 10A-10B, 14A-14B, 15A-15B, and 16A-16B show that a number of PSs included in the first group is 2 and a number of PSs included in the second group is 1, any number of PSs can be included in each of the first group and the second group.

In case the first group includes a plurality of PSs, the plurality of PSs may be applied alternately during the time period that is allocated for the first group (i.e., the above discussed first period). For example, in FIG. 15B, the first group of PSs includes the 2D BP PS and the 3D BP PS, and the two BP PSs are applied alternately during the first time period 1502.

In FIG. 15B, the time duration of applying the 2D BP PS and the time duration of applying the 3D BP PS are the same. But there may be a scenario where it may be beneficial to apply the 2D BP PS and the 3D BP PS for different durations. For example, if it is determined that the 2D BP PS performed better than the 3D BP PS, it may be beneficial to apply the 2D BP PS for a longer time duration as compared to the time duration of applying the 3D BP PS.

Therefore, according to some embodiments, the time period of applying one or more PSs included in the first group of PSs within the time period allocated to the first group of PSs is adjusted based on the performance of one or more PSs included in the first group of PSs and/or the performance of one or more PSs included in the second group of PSs. Additionally or alternatively, the time period of applying one or more PSs included in the second group of PSs within the time period allocated to the second group of PSs may be adjusted based on the performance of one or more PSs included in the first group of PSs and/or the performance of one or more PSs included in the second group of PSs.

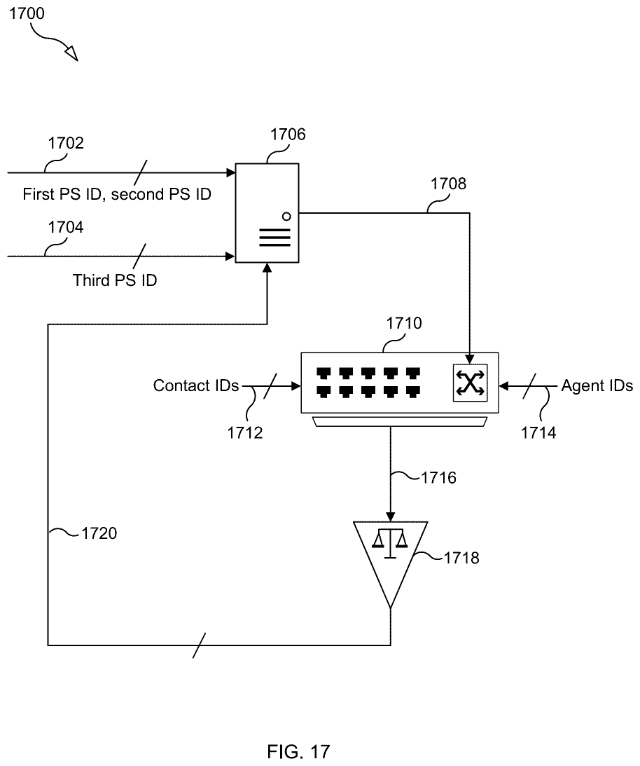

FIG. 17 shows an apparatus 1700 for adjusting the time period of applying one or more PSs included in the first group of PSs and/or the second group of PSs, according to some embodiments. The apparatus 1700 may comprise an adjuster 1706, a switch 1710, and an evaluator 1718. The adjustor 1706 is configured to receive first PS group information 1702 and second PS group information 1704. The first PS group information 1702 may comprise one or more PS identifiers (“IDs”) identifying one or more PSs included in a first group of PSs. Similarly, the second group information 1704 may comprise one or more PS IDs identifying one or more PSs included in a second group of PSs.

In the example shown in FIG. 17, the first PS group information 1702 comprises a first PS ID identifying a first PS and a second PS ID identifying a second PS, and the second PS group information 1704 comprises a third PS ID identifying a third PS. However, as mentioned above, the number of PSs included in the first group and/or the second group can be any number. Also, even though FIG. 17 shows that the adjustor 1706 receives the first PS group information 1702 and the second PS group information 1704, in other embodiments, the adjustor 1706 may generate the first PS group information 1702 and the second PS group information 1704. In such embodiments, the adjustor 1706 would not receive the first PS group information 1702 and the second PS group information 1704. Alternatively, the first PS group information 1702 and the second PS group information 1704 may be stored in a storage medium (e.g., a memory) of the adjustor 1706, and the adjustor 1706 may simply retrieve from the storage medium the first PS group information 1702 and the second PS group information 1704.

After obtaining the first PS group information 1702 and the second PS group information 1704, the adjustor 1706 may determine a time ratio of applying the first group of PSs and/or the second group of PSs within a given time interval. The value of this time ratio is called “a proportion value.” The proportion value indicates a proportion of applying the first group of PSs within the given time interval or a proportion of applying the second group of PSs within the given time interval. Initially, this proportion value may be set to be a predefined value.

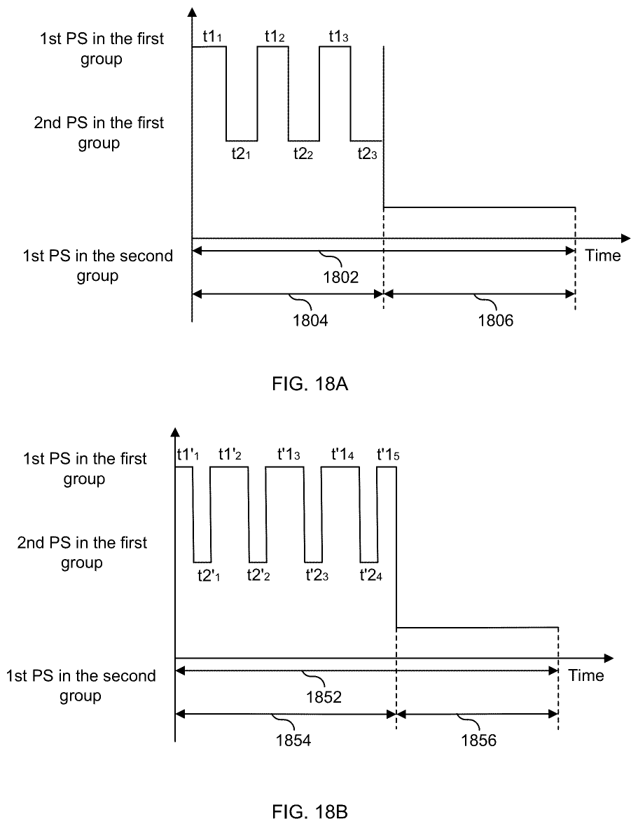

For example, in FIG. 18A, during a given time period 1802, each of the first group of PSs and the second group of PSs is applied during 50% of the time period 1802. More specifically, the first PS and the second PS included in the first group are applied during a time period 1804 which is 50% of the time period 1802, and the third PS included in the second group is applied during a time period 1806 which is also 50% of the time period 1802. Here, the proportion value is 0.5 or 50%.

In another example, in FIG. 18B, during a given time period 1852, the first group of PSs is applied during 70% of the time period 1852 while the second group of PSs is applied during 30% of the time period 1852. More specifically, the first PS and the second PS included in the first group are applied during a time period 1854 which is 70% of the time period 1852, and the third PS included in the second group is applied during a time period 1856 which is 30% of the time period 1852. Here, the proportion value may be 0.7 or 70%, or 0.3 or 30%.

In addition to determining the proportion value, after obtaining the first PS group information 1702 and the second PS group information 1704, the adjustor 1706 may also determine a time ratio of applying the first PS or the second PS included in the first PS group during the time period allocated to the first group of PSs. The value of this time ratio is called “a sub-proportion value.” The sub-proportion value indicates a sub-proportion of applying the first PS or the second PS included in the first group of PSs within the time period allocated to the first group of PSs. Initially, this sub-proportion value may be set to be a predefined value.

For example, in FIG. 18A, during the time period 1804 (which is 50% of the time period 1802 and which is allocated to the first group of PSs), each of the first PS and the second PS included in the first group is applied during 50% of the time period 1804. More specifically, the first PS is applied during t1₁+t1₂+t1₃ which is 50% of the time period 1804, and the second PS is applied during t2₁+t2₂+t2₃ which is also 50% of the time period 1804. Here, the sub-proportion value is 0.5 or 50%.

In another example, in FIG. 18B, during the time period 1854 (which is 70% of the time period 1852 and which is allocated to the first group of PSs), the first PS is applied during about 66.6% of the time period 1854 and the second PS is applied during 33.3% of the time period 1854. More specifically, the first PS is applied during t1′₁+t1′₂+t1′₃+t1′₄+t1′₅ which is 66.6% of the time period 1854, and the second PS is applied during t2′₁+t2′₂+t2′₃+t2′₄ which is 33.3% of the time period 1854. Here, the sub-proportion value may be 0.666 or 60% or 0.333 or 33%.

The proportion value and the sub-proportion value determined by the adjustor 1706 may be provided to the switch 1710, and according to the received proportion value and the received sub-proportion value, the switch 1710 may pair one or more contact IDs to one or more agent IDs. For example, in the example shown in FIG. 18A, during a first part (t1₁+t1₂+t1₃) of the time period 1802, the switch 1710 may pair one or more contact IDs to one or more agent IDs using the first PS, and during a second part (t2₁+t2₂+t2₃) of the time period 1802, the switch 1710 may pair one or more contact IDs to one or more agent IDs using the second PS. Also, during a third part (1806) of the time period 1802, the switch 1710 may pair one or more contact IDs to one or more agent IDs using the third PS.

After applying the first, second, and third PSs during the time periods that are determined based on the proportion value and the sub-proportion value, the evaluator 1718 may evaluate the performance of the first PS, the second PS, and/or the third PS, thereby generating performance measurement data 1720 that indicates the performance of the first PS, the second PS, and/or the third PS.

The performance measurement data 1720 may include a first performance score indicating the performance of the first PS, a second performance score indicating the performance of the second PS, and/or a third performance score indicating the performance of the third PS. Performance of the pairing strategies may be determined according to any performance measurement methods as known in contact center environments. In one example, several methods of evaluating the performance of the first PS, the second PS, and/or the third PS are described in U.S. Pat. No. 10,122,860, which is hereby incorporated by reference. After generating the performance measurement data 1720, the evaluator 1718 may transmit the performance measurement data 1720 to the adjustor 1706.

Based on the received performance measurement data 1720, the adjustor 1706 may adjust the proportion value and/or the sub-proportion value. More specifically, in some embodiments, the adjustor 1706 may evaluate one or more of the first, second, and third performance scores, and adjust the proportion value and/or the sub-proportion value based on the evaluation.

For example, the adjustor 1706 may compare each of the first performance score and the second performance score to a reference value, and adjust the proportion value and/or the sub-proportion value based on the evaluation. In case one of the first performance score and the second performance score is greater than or equal to the reference value while another one of the first performance score and the second performance score is lower than the reference value, the adjustor 1706 may adjust the sub-proportion value such that the PS having the performance score that is greater than the reference value is applied longer (e.g., having a greater sub-proportion value) as compared to the PS having the performance score that is lower than the reference value (e.g., having a lower sub-proportion value).

More specifically, in the example provided in FIG. 18A, each of the first PS and the second PS is applied during 50% of the time period 1804. But, in case that the adjustor 1706 determines that the first performance score indicating the performance of the first PS is greater than the reference value while the second performance score indicating the performance of the second PS is less than the reference value, as shown in FIG. 18B, the adjustor 1706 may increase the time period of applying the first PS while reducing the time period of applying the second PS.

Also, in the above example, in case both of the first performance score and the second performance score is lower than the reference value or in case both of the first performance score and the second performance score is higher than the reference value, the sub-proportion value may be adjusted based on a comparison of the first performance score and the second performance score. More specifically, in case the first performance score is higher than the second performance score, the adjustor 1706 may adjust the sub-proportion value such that the first PS is applied longer than the second PS during the time period allocated to the first group of PSs (e.g., 1804 in FIG. 18A or 1854 in FIG. 18B).

In another example, the sub-proportion value may be adjusted solely based on a comparison of the first PS and the second PS (without considering the reference value). In such example, in case the first performance score is higher than the second performance score, the adjustor 1706 may adjust the sub-proportion value such that the first PS is applied longer than the second PS during the time period allocated to the first group of PSs. On the other hand, in case the first performance score is lower than the second performance score, the adjustor 1706 may adjust the sub-proportion value such that the second PS is applied longer than the first PS during the time period allocated to the first group of PSs.

The reference value may be a pre-defined value or may be calculated based on one or more of the first, second, and/or third performance scores. For example, the reference value may be based on an average of the performance scores for a set of pairing strategies (e.g., the first and the second performance scores of the first group of PSs) or may be an average of performance values for pairing strategies in both the first group of PSs and the second group of PSs (e.g., the first, second, and third performance scores). In another example, the reference value may be based on the third performance score (but not the performance scores from the first group of PSs). In another example, the reference value may be based on a moving average over a period of time (e.g., 1 day, 2 days, 3 days, 5 days, 7 days, 14 days, 21 days, one month) for a set of pairing strategies, for all applied pairing strategies, and/or for any individual pairing strategy.

There are different ways to adjust the proportion value and the sub-proportion value according to the performance of the first PS, the second PS, and/or the third PS.

In some embodiments, the amount of the adjustment made to the proportion value or the sub-proportion value may be determined in proportion to the amount of the difference between a performance score and the reference value. For example, in case the sub-proportion value indicates the time duration of applying the first PS, the sub-proportion value may be adjusted based on the performance of the first PS such that the sub-proportion value is equal to A*(B-C) where A is a real number, B is the first performance score indicating the performance of the first PS, and C is the reference value. In some embodiments, the amount of the adjustment made to the proportion value or the sub-proportion value may be determined in proportion to the amount of the difference between a performance score for one PS as compared to a set of pairing strategies, for all applied pairing strategies, and/or for any other individual pairing strategy.

In other embodiments, the proportion value and/or the sub-proportion value may be determined using approaches such as Thompson sampling approach or Multi-armed bandit approach.

Note that FIG. 17 is merely a conceptual diagram of the apparatus according to the embodiments of this disclosure. It may not show real physical aspects the apparatus. In other words, the physical characteristics of the apparatus shown in FIG. 17 do not limit the embodiments of this disclosure in any way. For example, in some embodiments, any two or more of the adjustor 1706, the switch 1710, and the evaluator 1708 may be included in a single entity (e.g., a processor).

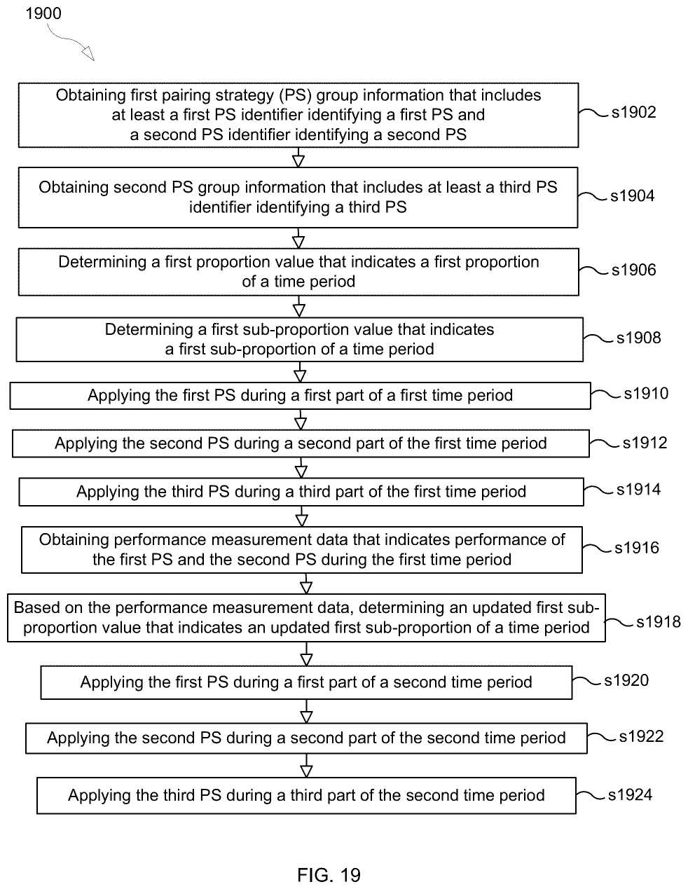

FIG. 19 shows a process 1900 according to some embodiments. The process 1900 may begin with step s1902. The step s1902 comprises obtaining first pairing strategy (PS) group information that includes at least a first PS identifier identifying a first PS and a second PS identifier identifying a second PS. Step s1904 comprises obtaining second PS group information that includes at least a third PS identifier identifying a third PS. Step s1906 comprises determining a first proportion value that indicates a first proportion of a time period, wherein the first proportion is associated with (i) the first PS identifier and the second PS identifier or (ii) the third PS identifier. Step s1908 comprises determining a first sub-proportion value that indicates a first sub-proportion of a time period, wherein the first sub-proportion is associated with the first PS identifier or the second PS identifier. Step s1910 comprises applying the first PS during a first part of a first time period, wherein the first part of the first time period is selected based on the first proportion value and the first sub-proportion value. Step s1912 comprises applying the second PS during a second part of the first time period, wherein the second part of the first time period is selected based on the first proportion value and the first sub-proportion. Step s1914 comprises applying the third PS during a third part of the first time period, wherein the third part of the first time period is selected based on the first proportion value. Step s1916 comprises obtaining performance measurement data that indicates performance of the first PS and the second PS during the first time period. Step s1918 comprises, based on the performance measurement data, determining an updated first sub-proportion value that indicates an updated first sub-proportion of a time period, wherein the updated first sub-proportion is associated with the first PS identifier or the second PS identifier. Step s1920 comprises applying the first PS during a first part of a second time period, wherein the first part of the second time period is selected based on the updated first sub-proportion value. Step s1922 comprises applying the second PS during a second part of the second time period, wherein the second part of the second time period is selected based on the updated first sub-proportion value. Step s1924 comprises applying the third PS during a third part of the second time period.

In some embodiments, the first proportion value indicates a proportion of a given time period for applying (i) at least one of the first PS and the second PS but not the third PS or (ii) the third PS but not the first PS and the second PS, and the given time period is for applying all of the first PS, the second PS, and the third PS.

In some embodiments, the first sub-proportion value indicates a sub-proportion of the given time period for applying (i) the first PS but not the second PS or (ii) the second PS but not the first PS, and the proportion of the given time period is for applying both the first PS and the second PS.

In some embodiments, a length of the third part of the first time period and a length of the third part of the second time period are same.

In some embodiments, the first part of the second time period is selected based on the updated first sub-proportion value and the first proportion value, the second part of the second time period is selected based on the updated first sub-proportion value and the first proportion value, and the third part of the second time period is selected based on the first proportion value.

In some embodiments, a length of the third part of the first time period and a length of the third part of the second time period are different.

In some embodiments, the process 1900 comprises determining an updated first proportion value that indicates an updated first proportion of a time period, wherein the first proportion value and the updated first proportion value are different, the updated first proportion is associated with (i) the first PS and the second PS or (ii) the third PS, the first part of the second time period is selected based on the updated first sub-proportion value and the updated first proportion value, the second part of the second time period is selected based on the updated first sub-proportion value and the updated first proportion value, and the third part of the second time period is selected based on the updated first proportion value.

In some embodiments, the updated first proportion value is determined based on the performance measurement data.

In some embodiments, the first PS group information includes a first set of PS identifiers identifying a first set of PSs, the first set of PSs includes the first PS and the second PS, the second PS group information includes a second set of PS identifiers identifying a second set of PSs, the second set of PSs includes the third PS, the first proportion value indicates a proportion of the given time period for applying (i) the first set of PSs but not the second set of PSs or (ii) the second set of PSs but not the first set of PSS, and the given time period is for applying both the first set of PSs and the second set of PSs.

In some embodiments, the first sub-proportion value indicates a sub-proportion of the given time period for applying only one PS included in the first set of PSs, and the proportion of the given time period is for applying the first set of PSs.

In some embodiments, the process 1900 comprises obtaining updated first PS group information that includes an updated first set of PS identifiers identifying an updated first set of PSs; and/or obtaining second PS group information that includes an updated second set of PS identifiers identifying an updated second set of PSs, wherein the first set of PSs and the updated first set of PSs are different, and/or the second set of PSs and the updated second set of PSs are different.

In some embodiments, the performance of the first PS and the second PS during the first time period is determined based on a number of pairings performed using the third PS.

In some embodiments, applying the first PS or the second PS comprises selecting agents from a set of agents for pairing with contacts, and applying the third PS comprises selecting agents from the same set of agents for pairing with contacts.

In some embodiments, each of a length of the first time period and a length of the second time period is one day.

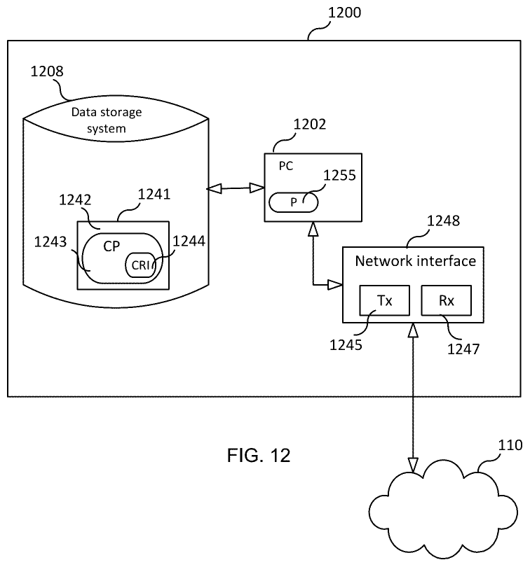

FIG. 12 is a block diagram of an apparatus 1200, according to some embodiments, for performing the method shown in FIG. 11. As shown in FIG. 12, apparatus 1200 may comprise: processing circuitry (PC) 1202, which may include one or more processors (P) 1255 (e.g., a general purpose microprocessor and/or one or more other processors, such as an application specific integrated circuit (ASIC), field-programmable gate arrays (FPGAs), and the like), which processors may be co-located in a single housing or in a single data center or may be geographically distributed (i.e., apparatus 1200 may be a distributed computing apparatus); a network interface 1248 comprising a transmitter (Tx) 1245 and a receiver (Rx) 1247 for enabling apparatus 1200 to transmit data to and receive data from other nodes connected to a network 110 (e.g., an Internet Protocol (IP) network) to which network interface 1248 is connected (directly or indirectly) (e.g., network interface 1248 may be wirelessly connected to the network 110, in which case network interface 1248 is connected to an antenna arrangement); and a local storage unit (a.k.a., “data storage system”) 1208, which may include one or more non-volatile storage devices and/or one or more volatile storage devices. In embodiments where PC 1202 includes a programmable processor, a computer program product (CPP) 1241 may be provided. CPP 1241 includes a computer readable medium (CRM) 1242 storing a computer program (CP) 1243 comprising computer readable instructions (CRI) 1244. CRM 1242 may be a non-transitory computer readable medium, such as, magnetic media (e.g., a hard disk), optical media, memory devices (e.g., random access memory, flash memory), and the like. In some embodiments, the CRI 1244 of computer program 1243 is configured such that when executed by PC 1202, the CRI causes apparatus 1200 to perform steps described herein (e.g., steps described herein with reference to the flow charts). In other embodiments, apparatus 1200 may be configured to perform steps described herein without the need for code. That is, for example, PC 1202 may consist merely of one or more ASICs. Hence, the features of the embodiments described herein may be implemented in hardware and/or software.

At this point it should be noted that behavioral pairing in a contact center system in accordance with the present disclosure as described above may involve the processing of input data and the generation of output data to some extent. This input data processing and output data generation may be implemented in hardware or software. For example, specific electronic components may be employed in a behavioral pairing module or similar or related circuitry for implementing the functions associated with behavioral pairing in a contact center system in accordance with the present disclosure as described above. Alternatively, one or more processors operating in accordance with instructions may implement the functions associated with behavioral pairing in a contact center system in accordance with the present disclosure as described above. If such is the case, it is within the scope of the present disclosure that such instructions may be stored on one or more non-transitory processor readable storage media (e.g., a magnetic disk or other storage medium), or transmitted to one or more processors via one or more signals embodied in one or more carrier waves.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of at least one particular implementation in at least one particular environment for at least one particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

### SUMMARY OF VARIOUS EMBODIMENTS

A1. A method (1100) comprising: selecting (s1102) a pairing strategy (PS) set from a group of PS sets, the group of PS sets comprising: i) a first PS set comprising a first PS (first pairing algorithm/module) and ii) a second PS set comprising a second PS and a third PS; and as a result of selecting a PS set from the group of PS sets, using (s1104) one or more PSs included in the selected PS set to establish one or more contact-agent pairs.
A2. The method of embodiment A1, wherein selecting a PS set from the group of PS sets comprises: selecting a PS set from the group of PS sets based on a time value indicating a time of day or indicating an amount time that has elapsed since an epoch, or selecting a PS set from the group of PS sets based on a generated pseudo random value (PRV).
A3. The method of embodiment A1 or A2, further comprising: receiving at one or more switches contact information indicating a plurality of contacts available for pairing; and obtaining, by at least one computer processor communicatively coupled to and configured to operate in a contact center system, the contact information indicating the plurality of available contacts, wherein each of the plurality of available contacts is available for pairing to one of a plurality of available agents, wherein the step of using one or more PSs included in the selected PS set to establish one or more contact-agent pairs comprises selecting a PS included in the selected PS set and using the selected PS to pair one of the available contacts with one of the available agents.
A4. The method of embodiment A3, wherein the selected PS set is the second PS set, and selecting a PS included in the second PS set comprises generating a PRV and using the PRV to select a PS included in the second PS set.
A5. The method of embodiment A4, wherein the step of selecting a PS set from the group of PS sets comprises: determining the current time of day; and selecting a PS set include in the group of PS sets based on the determined current time of day.
A6. The method of embodiment A5, wherein the step of using the one or more PS included in the selected PS set to establish one or more contact-agent pairs comprises: for at least a first specified duration of time, using the one or more PSs included in the selected PS set to establish the one or more contact-agent pairs.
A7. The method of embodiment A6, wherein the selected PS set is the second PS set, the first PS set consists of the first PS, and the method further comprises: determining that the first specified duration of time has elapsed; and as a result of determining that the first specified duration of time has elapsed, for at least a second specified duration of time, using the first PS set to establish a plurality of contact-agent pairs.
A8. The method of embodiment A7, wherein the first PS is a first-in-first-out PS, the second PS is a two-dimensional behavioral PS, and the second PS is an n-dimensional behavioral PS, where n>2.
B1. A method (1300) comprising: obtaining (s1302) first contact center information, the first contact center information: i) identifying a first set of available agents that are available to be paired with a contact and ii) identifying a first set of contacts that are waiting to be paired with an available agent; selecting (s1304) a pairing strategy (PS) set from a group of two or more PS sets, the group of PS sets comprising: i) a first PS set comprising a first PS and ii) a second PS set comprising a second PS and a third PS; and after obtaining the first contact center information and after selecting the pairing strategy set, performing (s1306) a first pairing process using the first contact center information, wherein the first pairing process implements a PS included in the selected PS set.
B2. The method of embodiment B1, further comprising, after performing the first pairing process: obtaining second contact center information, the second contact center information: i) identifying a second set of available agents that are available to be paired with a contact and ii) identifying a second set of contacts that are waiting to be paired with an available agent; selecting one of the PS sets included in the group of PS sets; and after obtaining the second contact center information and selecting one of the PS sets included in the group of PS sets, performing a second pairing process using the second contact center information, wherein the second pairing process implements a PS included in the most recently selected PS set.
C1. A method (1900) comprising: obtaining (s1902) first pairing strategy (PS) group information that includes at least a first PS identifier identifying a first PS and a second PS identifier identifying a second PS; obtaining (s1904) second PS group information that includes at least a third PS identifier identifying a third PS; determining (s1906) a first proportion value that indicates a first proportion of a time period, wherein the first proportion is associated with (i) the first PS identifier and the second PS identifier or (ii) the third PS identifier; determining (s1908) a first sub-proportion value that indicates a first sub-proportion of a time period, wherein the first sub-proportion is associated with the first PS identifier or the second PS identifier; applying (s1910) the first PS during a first part of a first time period, wherein the first part of the first time period is selected based on the first proportion value and the first sub-proportion value; applying (s1912) the second PS during a second part of the first time period, wherein the second part of the first time period is selected based on the first proportion value and the first sub-proportion; applying (s1914) the third PS during a third part of the first time period, wherein the third part of the first time period is selected based on the first proportion value; obtaining (s1916) performance measurement data that indicates performance of the first PS and the second PS during the first time period; based on the performance measurement data, determining (s1918) an updated first sub-proportion value that indicates an updated first sub-proportion of a time period, wherein the updated first sub-proportion is associated with the first PS identifier or the second PS identifier; applying (s1920) the first PS during a first part of a second time period, wherein the first part of the second time period is selected based on the updated first sub-proportion value; applying (s1922) the second PS during a second part of the second time period, wherein the second part of the second time period is selected based on the updated first sub-proportion value; and applying (s1924) the third PS during a third part of the second time period.
C2. The method of embodiment C1, wherein the first proportion value indicates a proportion of a given time period for applying (i) at least one of the first PS and the second PS but not the third PS or (ii) the third PS but not the first PS and the second PS, and the given time period is for applying all of the first PS, the second PS, and the third PS.
C3. The method of embodiment C2, wherein the first sub-proportion value indicates a sub-proportion of the given time period for applying (i) the first PS but not the second PS or (ii) the second PS but not the first PS, and the proportion of the given time period is for applying both the first PS and the second PS.
C4. The method of any one of embodiments C1-C3, wherein a length of the third part of the first time period and a length of the third part of the second time period are same.
C5. The method of embodiment C4, wherein the first part of the second time period is selected based on the updated first sub-proportion value and the first proportion value, the second part of the second time period is selected based on the updated first sub-proportion value and the first proportion value, and the third part of the second time period is selected based on the first proportion value.
C6. The method of embodiment C1, a length of the third part of the first time period and a length of the third part of the second time period are different.
C7. The method of embodiment C6, comprising: determining an updated first proportion value that indicates an updated first proportion of a time period, wherein the first proportion value and the updated first proportion value are different, the updated first proportion is associated with (i) the first PS and the second PS or (ii) the third PS, the first part of the second time period is selected based on the updated first sub-proportion value and the updated first proportion value, the second part of the second time period is selected based on the updated first sub-proportion value and the updated first proportion value, and the third part of the second time period is selected based on the updated first proportion value.
C8. The method of embodiment C7, wherein the updated first proportion value is determined based on the performance measurement data.
C9. The method of any one of embodiments C2-C8, wherein the first PS group information includes a first set of PS identifiers identifying a first set of PSs, the first set of PSs includes the first PS and the second PS, the second PS group information includes a second set of PS identifiers identifying a second set of PSs, the second set of PSs includes the third PS, the first proportion value indicates a proportion of the given time period for applying (i) the first set of PSs but not the second set of PSs or (ii) the second set of PSs but not the first set of PSS, and the given time period is for applying both the first set of PSs and the second set of PSs.
C10. The method of embodiment C9, wherein the first sub-proportion value indicates a sub-proportion of the given time period for applying only one PS included in the first set of PSs, and the proportion of the given time period is for applying the first set of PSs.
C11. The method of embodiment C9 or C10, comprising: obtaining updated first PS group information that includes an updated first set of PS identifiers identifying an updated first set of PSs; and/or obtaining second PS group information that includes an updated second set of PS identifiers identifying an updated second set of PSs, wherein the first set of PSs and the updated first set of PSs are different, and/or the second set of PSs and the updated second set of PSs are different.
C12. The method of any one of embodiments C1-C11, wherein the performance of the first PS and the second PS during the first time period is determined based on a number of pairings performed using the third PS.
C13. The method of any one of embodiments C1-C11, wherein applying the first PS or the second PS comprises selecting agents from a set of agents for pairing with contacts, and applying the third PS comprises selecting agents from the same set of agents for pairing with contacts.
C14. The method of any one of embodiments C1-C13, wherein each of a length of the first time period and a length of the second time period is one day.
D1. A computer program (1243) comprising instructions (1244) which when executed by processing circuitry (1202) cause the processing circuitry to perform the method of any one of embodiments A1-C14.
D2. A carrier containing the computer program of embodiment D1, wherein the carrier is one of an electronic signal, an optical signal, a radio signal, and a computer readable storage medium.
E1. An apparatus (1200), the apparatus being configured to: select (s1102) a pairing strategy (PS) set from a group of PS sets, the group of PS sets comprising: i) a first PS set comprising a first PS (first pairing algorithm/module) and ii) a second PS set comprising a second PS and a third PS; and as a result of selecting a PS set from the group of PS sets, use (sl104) one or more PSs included in the selected PS set to establish one or more contact-agent pairs.
E2. The apparatus of embodiment E1, wherein the apparatus is further configured to perform the method of any one of embodiments A2-A8.
F1. An apparatus (1200), the apparatus being configured to: obtain (s1302) first contact center information, the first contact center information: i) identifying a first set of available agents that are available to be paired with a contact and ii) identifying a first set of contacts that are waiting to be paired with an available agent; select (s1304) a pairing strategy (PS) set from a group of two or more PS sets, the group of PS sets comprising: i) a first PS set comprising a first PS and ii) a second PS set comprising a second PS and a third PS; and after obtaining the first contact center information and after selecting the pairing strategy set, perform (s1306) a first pairing process using the first contact center information, wherein the first pairing process implements a PS included in the selected PS set.
F2. The apparatus of embodiment F1, wherein the apparatus is further configured to perform the method of embodiment B2.
G1. An apparatus (1200) being configured to: obtain (s1902) first pairing strategy (PS) group information that includes at least a first PS identifier identifying a first PS and a second PS identifier identifying a second PS; obtain (s1904) second PS group information that includes at least a third PS identifier identifying a third PS; determine (s1906) a first proportion value that indicates a first proportion of a time period, wherein the first proportion is associated with (i) the first PS identifier and the second PS identifier or (ii) the third PS identifier; determine (s1908) a first sub-proportion value that indicates a first sub-proportion of a time period, wherein the first sub-proportion is associated with the first PS identifier or the second PS identifier; apply (s1910) the first PS during a first part of a first time period, wherein the first part of the first time period is selected based on the first proportion value and the first sub-proportion value; apply (s1912) the second PS during a second part of the first time period, wherein the second part of the first time period is selected based on the first proportion value and the first sub-proportion; apply (s1914) the third PS during a third part of the first time period, wherein the third part of the first time period is selected based on the first proportion value; obtain (s1916) performance measurement data that indicates performance of the first PS and the second PS during the first time period; based on the performance measurement data, determine (s1918) an updated first sub-proportion value that indicates an updated first sub-proportion of a time period, wherein the updated first sub-proportion is associated with the first PS identifier or the second PS identifier; apply (s1920) the first PS during a first part of a second time period, wherein the first part of the second time period is selected based on the updated first sub-proportion value; apply (s1922) the second PS during a second part of the second time period, wherein the second part of the second time period is selected based on the updated first sub-proportion value; and apply (s1924) the third PS during a third part of the second time period.
H1. An apparatus (1200), the apparatus comprising: a memory (1242); and processing circuitry (1202) coupled to the memory, wherein the apparatus is configured to perform the method of any one of embodiments A1-C14.

While various embodiments are described herein, it should be understood that they have been presented by way of example only, and not limitation. Thus, the breadth and scope of this disclosure should not be limited by any of the above described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A method comprising:
selecting a pairing strategy (PS) set from a group of PS sets, the group of PS sets comprising: i) a first PS set comprising a first PS and ii) a second PS set comprising a second PS and a third PS; and
as a result of selecting a PS set from the group of PS sets, using one or more PSs included in the selected PS set to establish one or more contact-agent pairs.

2. The method of claim 1, wherein selecting a PS set from the group of PS sets comprises:
selecting a PS set from the group of PS sets based on a time value indicating a time of day or indicating an amount time that has elapsed since an epoch, or
selecting a PS set from the group of PS sets based on a generated pseudo random value (PRV).

3. The method of claim 1, further comprising:
receiving at one or more switches contact information indicating a plurality of contacts available for pairing; and
obtaining, by at least one computer processor communicatively coupled to and configured to operate in a contact center system, the contact information indicating the plurality of available contacts, wherein each of the plurality of available contacts is available for pairing to one of a plurality of available agents, wherein
the step of using one or more PSs included in the selected PS set to establish one or more contact-agent pairs comprises selecting a PS included in the selected PS set and using the selected PS to pair one of the available contacts with one of the available agents.

4. The method of claim 3, wherein
the selected PS set is the second PS set, and
selecting a PS included in the second PS set comprises generating a PRV and using the PRV to select a PS included in the second PS set.

5. The method of claim 4, wherein the step of selecting a PS set from the group of PS sets comprises:
determining the current time of day; and
selecting a PS set include in the group of PS sets based on the determined current time of day.

6. The method of claim 5, wherein the step of using the one or more PS included in the selected PS set to establish one or more contact-agent pairs comprises:
for at least a first specified duration of time, using the one or more PSs included in the selected PS set to establish the one or more contact-agent pairs.

7. The method of claim 6, wherein
the selected PS set is the second PS set,
the first PS set consists of the first PS, and
the method further comprises:
determining that the first specified duration of time has elapsed; and
as a result of determining that the first specified duration of time has elapsed, for at least a second specified duration of time, using the first PS set to establish a plurality of contact-agent pairs.

8. The method of claim 7, wherein
the first PS is a first-in-first-out PS,
the second PS is a two-dimensional behavioral PS, and
the second PS is an n-dimensional behavioral PS, where n>2.

9. A method comprising:
obtaining first contact center information, the first contact center information: i) identifying a first set of available agents that are available to be paired with a contact and ii) identifying a first set of contacts that are waiting to be paired with an available agent;
selecting a pairing strategy (PS) set from a group of two or more PS sets, the group of PS sets comprising: i) a first PS set comprising a first PS and ii) a second PS set comprising a second PS and a third PS; and
after obtaining the first contact center information and after selecting the pairing strategy set, performing a first pairing process using the first contact center information, wherein the first pairing process implements a PS included in the selected PS set.

10. The method of claim 9, further comprising, after performing the first pairing process:
obtaining second contact center information, the second contact center information: i) identifying a second set of available agents that are available to be paired with a contact and ii) identifying a second set of contacts that are waiting to be paired with an available agent;
selecting one of the PS sets included in the group of PS sets; and
after obtaining the second contact center information and selecting one of the PS sets included in the group of PS sets, performing a second pairing process using the second contact center information, wherein the second pairing process implements a PS included in the most recently selected PS set.

11. A method comprising:
obtaining first pairing strategy (PS) group information that includes at least a first PS identifier identifying a first PS and a second PS identifier identifying a second PS;
obtaining second PS group information that includes at least a third PS identifier identifying a third PS;
determining a first proportion value that indicates a first proportion of a time period, wherein the first proportion is associated with (i) the first PS identifier and the second PS identifier or (ii) the third PS identifier;
determining a first sub-proportion value that indicates a first sub-proportion of a time period, wherein the first sub-proportion is associated with the first PS identifier or the second PS identifier;
applying the first PS during a first part of a first time period, wherein the first part of the first time period is selected based on the first proportion value and the first sub-proportion value;
applying the second PS during a second part of the first time period, wherein the second part of the first time period is selected based on the first proportion value and the first sub-proportion;
applying the third PS during a third part of the first time period, wherein the third part of the first time period is selected based on the first proportion value;
obtaining performance measurement data that indicates performance of the first PS and the second PS during the first time period;
based on the performance measurement data, determining an updated first sub-proportion value that indicates an updated first sub-proportion of a time period, wherein the updated first sub-proportion is associated with the first PS identifier or the second PS identifier;
applying the first PS during a first part of a second time period, wherein the first part of the second time period is selected based on the updated first sub-proportion value;
applying the second PS during a second part of the second time period, wherein the second part of the second time period is selected based on the updated first sub-proportion value; and
applying the third PS during a third part of the second time period.

12. The method of claim 11, wherein
the first proportion value indicates a proportion of a given time period for applying (i) at least one of the first PS and the second PS but not the third PS or (ii) the third PS but not the first PS and the second PS, and
the given time period is for applying all of the first PS, the second PS, and the third PS.

13. The method of claim 12, wherein
the first sub-proportion value indicates a sub-proportion of the given time period for applying (i) the first PS but not the second PS or (ii) the second PS but not the first PS, and
the proportion of the given time period is for applying both the first PS and the second PS.

14. The method of claim 11, wherein a length of the third part of the first time period and a length of the third part of the second time period are same.

15. The method of claim 14, wherein
the first part of the second time period is selected based on the updated first sub-proportion value and the first proportion value,
the second part of the second time period is selected based on the updated first sub-proportion value and the first proportion value, and
the third part of the second time period is selected based on the first proportion value.

16. The method of claim 11, a length of the third part of the first time period and a length of the third part of the second time period are different.

17. The method of claim 16, comprising:
determining an updated first proportion value that indicates an updated first proportion of a time period, wherein
the first proportion value and the updated first proportion value are different,
the updated first proportion is associated with (i) the first PS and the second PS or (ii) the third PS,
the first part of the second time period is selected based on the updated first sub-proportion value and the updated first proportion value,
the second part of the second time period is selected based on the updated first sub-proportion value and the updated first proportion value, and
the third part of the second time period is selected based on the updated first proportion value.

18. The method of claim 17, wherein the updated first proportion value is determined based on the performance measurement data.

19. The method of claim 12, wherein
the first PS group information includes a first set of PS identifiers identifying a first set of PSs,
the first set of PSs includes the first PS and the second PS,
the second PS group information includes a second set of PS identifiers identifying a second set of PSs,
the second set of PSs includes the third PS,
the first proportion value indicates a proportion of the given time period for applying (i) the first set of PSs but not the second set of PSs or (ii) the second set of PSs but not the first set of PSS, and
the given time period is for applying both the first set of PSs and the second set of PSs.

20. The method of claim 19, wherein
the first sub-proportion value indicates a sub-proportion of the given time period for applying only one PS included in the first set of PSs, and
the proportion of the given time period is for applying the first set of PSs.

21. The method of claim 19, comprising:
obtaining updated first PS group information that includes an updated first set of PS identifiers identifying an updated first set of PSs; and/or
obtaining second PS group information that includes an updated second set of PS identifiers identifying an updated second set of PSs, wherein
the first set of PSs and the updated first set of PSs are different, and/or
the second set of PSs and the updated second set of PSs are different.

22. The method of claim 11, wherein the performance of the first PS and the second PS during the first time period is determined based on a number of pairings performed using the third PS.

23. The method of claim 11, wherein
applying the first PS or the second PS comprises selecting agents from a set of agents for pairing with contacts, and
applying the third PS comprises selecting agents from the same set of agents for pairing with contacts.

24. The method of claim 11, wherein each of a length of the first time period and a length of the second time period is one day.

25. A non-transitory computer readable storage medium storing a computer program comprising instructions which when executed by processing circuitry cause the processing circuitry to perform the method of claim 1.

26. A non-transitory computer readable storage medium storing a computer program comprising instructions which when executed by processing circuitry cause the processing circuitry to perform the method of claim 9.

27. A non-transitory computer readable storage medium storing a computer program comprising instructions which when executed by processing circuitry cause the processing circuitry to perform the method of claim 11.

28. An apparatus, the apparatus comprising:
a memory; and
processing circuitry coupled to the memory, wherein the apparatus is configured to:
select a pairing strategy (PS) set from a group of PS sets, the group of PS sets comprising: i) a first PS set comprising a first PS (first pairing algorithm/module) and ii) a second PS set comprising a second PS and a third PS; and
as a result of selecting a PS set from the group of PS sets, use one or more PSs included in the selected PS set to establish one or more contact-agent pairs.

29. An apparatus, the apparatus comprising:
a memory; and
processing circuitry coupled to the memory, wherein the apparatus is configured to:
obtain first contact center information, the first contact center information: i) identifying a first set of available agents that are available to be paired with a contact and ii) identifying a first set of contacts that are waiting to be paired with an available agent;
select a pairing strategy (PS) set from a group of two or more PS sets, the group of PS sets comprising: i) a first PS set comprising a first PS and ii) a second PS set comprising a second PS and a third PS; and
after obtaining the first contact center information and after selecting the pairing strategy set, perform a first pairing process using the first contact center information, wherein the first pairing process implements a PS included in the selected PS set.

30. An apparatus, the apparatus comprising:
a memory; and
processing circuitry coupled to the memory, wherein the apparatus is configured to:
obtain first pairing strategy (PS) group information that includes at least a first PS identifier identifying a first PS and a second PS identifier identifying a second PS;
obtain second PS group information that includes at least a third PS identifier identifying a third PS;
determine a first proportion value that indicates a first proportion of a time period, wherein the first proportion is associated with (i) the first PS identifier and the second PS identifier or (ii) the third PS identifier;
determine a first sub-proportion value that indicates a first sub-proportion of a time period, wherein the first sub-proportion is associated with the first PS identifier or the second PS identifier;
apply the first PS during a first part of a first time period, wherein the first part of the first time period is selected based on the first proportion value and the first sub-proportion value;
apply the second PS during a second part of the first time period, wherein the second part of the first time period is selected based on the first proportion value and the first sub-proportion;
apply the third PS during a third part of the first time period, wherein the third part of the first time period is selected based on the first proportion value;
obtain performance measurement data that indicates performance of the first PS and the second PS during the first time period;
based on the performance measurement data, determine an updated first sub-proportion value that indicates an updated first sub-proportion of a time period, wherein the updated first sub-proportion is associated with the first PS identifier or the second PS identifier;
apply the first PS during a first part of a second time period, wherein the first part of the second time period is selected based on the updated first sub-proportion value;
apply the second PS during a second part of the second time period, wherein the second part of the second time period is selected based on the updated first sub-proportion value; and
apply the third PS during a third part of the second time period.
